(19) United States
(12) Patent Application Publication
(10) Pub. No.: US 2026/0070776 A1
(43) Pub. Date: Mar. 12, 2026

(54) Automated Pod Filling and Multi-Chamber Substance Delivery System

(71) Applicant: VQDLABS Inc., Virginia Beach, VA (US)

(72) Inventors: Connor J. Blow, Christiansburg, VA (US); Serjan D. Nikolic, Virginia Beach, VA (US); John L. Felt, Christiansburg, VA (US)

(21) Appl. No.: 19/323,584

(22) Filed: Sep. 9, 2025

Related U.S. Application Data
(60) Provisional application No. 63/692,429, filed on Sep. 9, 2024.
(60) Provisional application No. 63/865,412, filed on Aug. 17, 2025.

(51) Int. Cl. B67D 7/02

(52) U.S. Cl. CPC B67D 7/02

(57) ABSTRACT

Systems and methods for automated filling and dual-channel aerosol delivery. A countertop hub with a positive-pressure source, manifold, and independently addressable line controllers co-delivers liquid from modular reservoirs into a multi-chamber pod; duty-cycled actuation interleaves micro-slugs so in-flow composition matches a commanded ratio, then the hub persists per-chamber composition and level to accessible memory via redundant handoff paths (pod memory, contactless write to a control body, or app/cloud sync). The control body reads the record and drives two atomization channels per puff—resistive and/or ultrasonic—to realize a target A:B mixture while maintaining perceived density from draw telemetry. A policy engine and inventory guardrails check content-class rules, manage purge/rinse, map any reservoir slot to any pod chamber, and adapt or block requests when volume falls below thresholds.

### BACKGROUND

The present disclosure relates to a vaping device and, more particularly, to a multi-chamber delivery device and methods of use.

Substance addiction is a widespread challenge with serious health implications. The journey to substance reduction is fraught with many challenges. Current methods of smoking or vaping cessation, such as cold turkey, nicotine replacement therapies (NRTs), and various pharmaceutical interventions, often pose significant hurdles for those seeking to overcome their addiction. The most pervasive issue among these methods is the high incidence of withdrawal symptoms, which can be severe enough to derail even the most committed attempts to quit. These symptoms range from irritability and mood swings to intense cravings and physiological discomfort, leading many to relapse.

The current substance reduction market includes solutions that either focus solely on replacing the method of substance delivery or offer temporary relief from withdrawal symptoms without addressing the underlying habit. For example, existing reduction methods often result in significant withdrawal symptoms, none of them which effectively minimize withdrawal discomfort and support a gradual weaning off substance. This gap in the market leaves many individuals trapped in a cycle of dependence, seeking a viable path to true freedom from substance.

Additionally, existing reduction products and programs fail to address the deeply personal and varied nature of substance addiction. They often adopt a one-size-fits-all approach that neglects the individual's usage patterns, lifestyle, and psychological readiness to quit. As a result, these methods show suboptimal success rates, leaving users feeling disillusioned and trapped in a cycle of dependency. Moreover, the economic burden of quitting cannot be understated. Many individuals find it difficult to afford the lump sum costs associated with NRTs and prescription medications, creating a barrier to entry for those who need help the most.

### SUMMARY

A vaporization system comprising: a hub including a positive-pressure pump, a fluid manifold, and multiple independently controllable flow controllers; a plurality of modular, removable liquid reservoirs each having an air-in actuation port and a liquid-out port; a multi-chamber pod configured to receive liquid into at least two independent chambers; and a control body configured to receive the pod; wherein during a single chamber fill, the hub co-delivers liquid from a selected set of one or more reservoirs into a target chamber so that the in-flow composition matches a commanded ratio when two or more reservoirs are selected, and after the fill a controller persists per-chamber composition and level in memory accessible to the control body.

The flow controllers are solenoid valves, and the hub achieves the commanded ratio by duty-cycling at least two valves during the fill to interleave micro-slugs upstream of the chamber inlet.

An oscillation cycle lies in a range of 1-200 Hz for mixture uniformity, and wherein when only one reservoir is selected the corresponding valve may be held open continuously (0 Hz).

The hub varies pump voltage and/or pulse-width modulation to maintain ratio fidelity across different viscosities.

Any physical reservoir slot is selectively mappable to any pod chamber under software control based on reservoir identity read from reservoir memory.

The hub comprises residual-fluid mitigation including at least one of: reverse stroke to withdraw liquid from lines, a user-accessible manual flush with quick-release tubing, and an automated rinse using a cleaning reservoir with a dump-pod routine.

The multi-chamber pod may include self-sealing refill interfaces that open only under proper hub engagement and a positive-pressure air-escape path to vent displaced gas during fills.

The multi-chamber pod may include a closed-loop vent path returns displaced gas from the pod to a reservoir or pump inlet to reduce emissions during fills.

Reservoirs each include on-module writable memory storing identity, content class and strength, batch/lot, and remaining volume updated after each fill, the hub using such data for type-safe fills and inventory.

The accessible memory to which the controller persists composition and level comprises at least one of: (i) on-pod non-volatile memory; (ii) control body memory updated via near-field transfer when the control body is tapped or rests on a hub cradle (inductive/charging region); and (iii) control body memory updated via Bluetooth® while the control body is docked or within a pairing range.

The system comprises a compliance rule engine that constrains blend options, fill operations, or device operation based on region/SKU flags in reservoir or pod metadata and inventory-aware guardrails that adapt requested ratios when a chamber falls below threshold volume.

The multi-chamber pod is scalable to three or more chambers; the hub being configured to co-deliver into different chambers in a single multi-chamber fill.

The system may comprise per-chamber user-perceptible indicators that render target or achieved chamber ratios as blended colors or intensity during fills.

The hub and an associated application synchronize fill events, consumption estimates, and inventory, and optionally trigger auto-reorder based on remaining mL logged in reservoir memory.

The pump comprises a peristaltic pump or micro-blower, and the flow controllers comprise valves or per-line pump channels.

The multi-chamber pod may include an on-pod memory field of maximum permitted drive envelope that the control body enforces for at least one atomizer.

The hub UI may expose a manual quick-disconnect to remove e-liquid lines for user-initiated cleaning or replacement without tools.

The multi-chamber pod-geometry may include anti-spit back and an internal mixing region upstream of a mouthpiece.

The multi-chamber pod includes a mechanical inner-volume reducer insertable at manufacture to comply with a 2 mL limit while preserving the base pod geometry.

In certain embodiments, the control body uses a pressure sensor to estimate draw strength and adjusts two atomization channels on a per-puff basis to maintain a target A:B composition while keeping perceived density substantially constant; haptic and/or audio cues indicate program limits and/or milestones.

The control body can include a user-adjustable airflow control with an electronically sensed position, so that airflow settings are captured in usage logs and incorporated into dose and experience analytics.

A representative refill apparatus provides a positive-pressure pump, a manifold, and N independently addressable line controllers coupled to N reservoir air-in ports, together with a pod docking interface having liquid couplers and a vent. When two or more reservoirs are selected for one chamber, a controller co-delivers liquid so that the in-flow composition matches a commanded ratio, and—after the fill—persists per-chamber composition/level to memory accessible to the control body.

To produce blends during a single chamber fill, the controller can duty-cycle at least two valves so that interleaved micro-slugs form upstream of the chamber inlet and achieve the commanded ratio.

In some builds, the hub writes the post-fill composition/level record to on-pod non-volatile memory.

Alternatively, or additionally, the hub writes to control body memory over a contactless near-field channel (e.g., NFC or an inductive-charging coil sideband) when the control body is either seated in the charge/data cradle or brought into short-range coupling proximity with a hub transceiver region, without requiring mechanical docking.

In other variants, the hub performs a Bluetooth® write-back to the control body while the pod remains docked at the hub.

The refill apparatus can employ sensors—e.g., pressure, flow, temperature, or plunger-travel—to calibrate or verify filled volumes and improve accuracy across formulations.

A cleaning reservoir may be selectively coupled so the hub can execute automated rinse and/or purge cycles between content classes, supporting cross-contamination control.

In some embodiments, the hub dynamically remaps any physical reservoir slot to any pod chamber using identities read from on-reservoir memory, enabling flexible slot→chamber assignments during a fill.

Records written by the hub (e.g., reservoir, pod, and fill session data) can include integrity fields such as checksums or cryptographic signatures to enable end-to-end verification before device use.

The hub's user interface may render ratio feedback with slot LEDs and pod-bay indicators, including blended colors that visualize A:B contribution during a fill.

The multi-chamber pod provides at least two independent liquid chambers, normally-sealed refill interfaces that open under hub engagement, a positive-pressure vent path for displaced gas, and a data interface through which composition/level results from a hub fill are persisted to memory accessible by the control body.

In certain variants, the data interface includes on-pod writable memory readable by the control body and/or hub to retrieve per-chamber composition and levels after a fill.

In other variants, pod contacts provide a bridge for the hub or control body to access off-pod storage (e.g., write to on-device memory or sync to cloud), enabling redundancy beyond on-pod flash.

A pod chamber can employ an ultrasonic atomizer; associated drive-limit metadata may be stored with the fill results, so the control body respects safe operating envelopes for that chamber.

Alternative builds use resistive heaters, with pod airflow geometry that mitigates spit-back and, where desired, an internal mixing region upstream of the mouthpiece

Refill interfaces can use self-sealing septa, spring-valve couplers, or O-ringed interlocks keyed to the hub's docking geometry, so ports remain closed unless properly engaged.

To meet jurisdictional capacity limits, the pod may include a removable or factory-installed mechanical insert that reduces total liquid volume to approximately ≤2 mL without changing outer geometry.

The control body receives the multi-chamber pod and provides two independently controllable atomizer channels; using composition/level data persisted after a hub fill, the controller modulates per-puff output to realize a target A:B blend for recreation or reduction while enforcing inventory guardrails.

In resistive-only embodiments, both channels drive coils under PWM to set the commanded A:B ratio.

In ultrasonic embodiments, at least one channel is an ultrasonic transducer; the controller modulates frequency and/or amplitude envelopes per puff according to program targets.

Hybrid configurations are contemplated in which one chamber is resistive-heated, and the other is ultrasonic, with coordinated envelopes to produce the commanded mixture.

The atomizers can be located in the pod and driven electrically by the control body through a pod interface.

User feedback can include haptic and audio outputs that provide pre-cap notices, limit-reached cues, and other prompts, with events recorded to logs.

A pressure sensor may detect user draw to initiate and regulate per-puff control, and an airflow adjuster can be electronically sensed so settings are logged and incorporated into analytics.

The device can support a “find-my-device” feature that actuates a buzzer/speaker 190, and LEDs 56a, 56b upon application command to help locate the control body 10.

In certain embodiments, the control body enforces inventory-aware guardrails by adapting—or, when necessary, refusing—a requested A:B composition whenever a chamber's remaining volume (as recorded after the hub fill) drops below a threshold, with the event surfaced to the user.

The control body 10 may incorporate an accelerometer for auto-wake and gesture inputs and can expose an optional, user-tunable daily puff budget that is coordinated with program cues and usage logs.

Airflow state (e.g., a user-set airflow adjuster position) can influence computed delivered dose and is included in session analytics persisted to system memory, improving dosing and program insights.

A representative fill method includes: detecting a docked pod; identifying reservoir contents and available volumes; receiving a target chamber composition; starting the pump and controlling per-line actuators so in-flow composition matches the commanded ratio (when multiple sources feed a chamber); stopping at a target volume or time; and persisting per-chamber composition and level to memory accessible by the control body.

To realize blends during a single fill, the controller can duty-cycle at least two line controllers so that interleaved micro-slugs form upstream of the chamber inlet, producing the commanded in-flow ratio.

Duty-cycle parameters may adapt to viscosity using lookup tables or sensor feedback (e.g., pressure/flow/plunger-travel), improving ratio fidelity across different formulations.

Between content classes, the hub can execute a rinse or purge workflow using a cleaning reservoir and a dump-pod routine to mitigate cross-contamination before enabling the next fill.

Persistence of fill results can occur via one or more redundant paths: write to on-pod non-volatile memory; contactless transfer to control body memory when the device rests in a cradle; or Bluetooth® write-back while the pod remains docked.

The hub can verify memory integrity with a checksum or signature over key fields and sync a Fill Session log to an application/cloud record for audit and inventory reconciliation.

During a fill, the user interface may visualize commanded ratios per chamber using on-hub LEDs; blended colors can indicate relative A and B contribution.

In some embodiments, slot to chamber mapping can be assigned dynamically from identities read on reservoir memories so that any physical slot can feed any pod chamber under software control.

The hub/App may predict reservoir runout from historical fills and device usage, prompting the user and, where configured, initiating an auto-reorder when a threshold is met.

Positive-pressure venting can be implemented with a closed-loop return path that routes displaced gas from the pod back to a reservoir or pump inlet during fills.

Content-class rules may prevent combining incompatible classes unless a purge routine is completed; in selectable modes, the system can alert and allow user override with appropriate logging and policy flags.

A representative delivery method reads per-chamber composition persisted after a hub fill; receives a recreation or reduction program; modulates two atomization channels per puff to meet the commanded A:B ratio subject to inventory and composition logs; and writes usage back to system memory.

In ultrasonic implementations, the controller drives frequency and/or amplitude envelopes per puff according to the program, optionally coordinating with a resistive channel in hybrid builds.

The delivery logic can adapt or refuse a requested ratio when remaining volume recorded after the hub fill falls below a threshold, thereby maintaining integrity of the program and preventing dry-run conditions.

Pre-cap and limit-reached cues (e.g., haptic or audio) can be issued during use, with override events captured in logs for later analytics and program adjustments.

After an active concentration reaches a given threshold, certain implementations enable a habit-taper mode that gradually reduces a user-tunable daily puff budget; pre-cap and cap-reached cues are delivered via haptic/audio outputs, and the airflow setting is incorporated into analytics.

Draw strength estimated from a pressure sensor is used to maintain substantially constant perceived density while holding the commanded A:B composition during each puff.

The control body can adapt taper tempo within guardrails based on learned user comfort signals or analytics (e.g., rollback on discomfort and smoothing between steps).

In ultrasonic embodiments, a dual-channel control body receives a multi-chamber pod; at least one channel is an ultrasonic transducer, and the controller computes per-puff ultrasonic frequency and/or amplitude envelopes from composition persisted after a hub-initiated fill.

Drive envelopes for ultrasonic channels can be constrained by limits stored with the fill results so the device respects safe operating bounds for a given chamber.

In hybrid builds, the controller coordinates ultrasonic envelopes with resistive power on the companion channel to realize the commanded A:B mixture per puff.

The ecosystem may support both personal and remote fulfillment using a common data model and memory-handoff paths.

A representative remote fill system includes a networked filling station that receives a user profile, couples to liquid sources, executes a multi-source fill into one or more chambers, and persists per-chamber composition/levels for shipment to the user.

Remote or local controllers can decrement on-source inventories recorded in reservoir memories and synchronize a fulfillment log or “Fill Session” with batch/lot and dispense deltas.

Software (e.g., an application or service) may implement instructions to retrieve hub/pod data, orchestrate a co-delivery recipe, verify persistence to accessible memory (checksum/signature), and update inventory/compliance logs.

In one selectable mode, the hub blocks cross-class operations unless a purge is completed; in another mode, it alerts the user and allows an override while logging the risk, with behavior keyed to jurisdictional settings.

Content-class interlocks and thresholds can be configured per policy bits stored in reservoir or pod metadata, allowing region/SKU-specific behavior without changing hardware.

UI/feedback and analytics. LEDs, speakers/buzzers, and app synchronization provide user feedback during fills and use, analytics and logs support program adjustments and inventory integrity.

The control body may include a speaker capable of tone patterns and per-chamber LEDs that reflect real-time or recently filled composition as blended colors during use or verification.

The hub and application can maintain local usage logs with pruning at storage thresholds, while the app/cloud layer retains full history for analytics and compliance.

User-tunable parameters may include taper speed, adaptive taper, daily-budget enable/disable, airflow preference, and feedback intensity, with settings recorded to system memory.

For volume-limited markets, the pod can accept tool-less inserts that reduce total capacity (e.g., to ≤2 mL) and are serialized for audit in the pod's data.

Industrial-capacity reservoirs can be coupled for remote or pharmacy filling while using the same data model and integrity checks as consumer reservoirs, enabling consistent logs and policy enforcement across fulfillment contexts.

The hub can authenticate reservoirs and pods using unique identifiers in on-module memories and can reject unrecognized modules before fill or use, improving inventory integrity and safety.

Slot color mapping and per-chamber window LEDs can visualize commanded or achieved ratios during fills (e.g., blended colors proportional to A:B).

The application may provide quiet-hours during which cues, and taper enforcement are softened, with user-acknowledged overrides logged to history.

The pod's electrical interface can support both memory access and atomizer drive using a daughterboard “cup” that aligns on-pod pads to spring pins in the control body, improving electrical robustness across insertions.

Personal and remote fills may share a common data model so that pods prepared at a remote station are immediately recognized by the hub and Control body and operated per their persisted compositions and limits.

The ecosystem includes an application that pairs with the hub and Adaptive Control body to orchestrate fills and per-puff programs using memory-handoff and verification flows.

In operation, the app provides a blend-builder UI for each chamber, sends fill requests to the hub, verifies that composition/levels were persisted via the disclosed write paths, and configures the Control body with per-puff targets for recreation or reduction, enforcing inventory guardrails.

Market/SKU rules can be enforced by the app using content-class flags read from reservoir or pod data, gating available programs and blends per jurisdiction while logging policy decisions.

A reduction program advances according to a monotonic schedule r_{H}(t) from 1.00 toward a predefined or user-specified target r_{H,target} using bounded micro-steps (e.g., r_{H}≤0.03 absolute per session or per day), with optional smoothing (linear or logistic) and rollback when a discomfort threshold is reported or analytics indicate relapse, until the target is reached.

The app may compute perceived-density compensation from draw telemetry and command the Control body to maintain substantially constant aerosol output while varying A:B composition, consistent with the pressure-sensor control disclosed for the device.

After the hub completes a fill, the app can transmit a signed composition record to the Control body via NFC/BLE/inductive cradle, allowing the device to operate on the record without requiring on-pod write-back.

The app can prompt the hub to verify reservoir/pod memories and to log a Fill Session containing batch/lot and dispense deltas for compliance and inventory reconciliation.

Reservoir runout prediction can be computed from historical Fill Sessions and device usage; when a threshold is met, the app may trigger an auto-reorder, maintaining supply continuity.

A habit-taper mode may decrement a daily puff budget after a composition reaches zero active concentration, coordinating pre-cap/cap-reached cues delivered by the device's haptic/audio outputs and logging user overrides.

The app may present quiet-hour windows during which the Control body down-modulates output or issues gentle nudges until the user overrides, aligning with the behavioral taper features above.

A find-my-device function can command the Control body to emit audio and LED signals and record last-seen location from the user device.

The app can orchestrate remote fills by transmitting a user profile to a networked station that executes oscillated multi-source fills and writes composition/levels to pod-associated data prior to shipment.

In certain implementations, the application stores per-profile drive constraints-such as ultrasonic frequency/amplitude envelopes or coil power limits-keyed to composition and configures the control body accordingly.

A representative app workflow pairs with the hub and control body, acquires reservoir and pod data, receives a user-selected recreation or reduction program with per-chamber ratios, initiates a fill at the hub, verifies that composition/levels were persisted via the disclosed handoff paths, and then loads per-puff modulation targets to the control body while enforcing inventory guardrails.

Program transitions can be smoothed using a bounded step size and/or logistic ramp, so successive sessions remain below a perceptual threshold for change.

In recreation mode, the device may hold a fixed A:B composition and maintains substantially constant perceived density by adjusting total output in response to draw-sensor input (pressure-sensor control described for the device and used by the app's density compensation).

In reduction mode, duty-cycle or ultrasonic envelopes shift gradually from a higher-strength chamber toward a lower-strength chamber on a per-puff or per-session basis until a specified target is reached.

After the active concentration reaches zero, a habit-taper feature may decrement a daily puff budget, coordinate pre-cap/cap-reached cues via on-device haptic/audio and log any overrides for analytics.

Step size in the reduction schedule can adapt based on user-reported comfort scores or relapse markers derived from usage analytics, subject to guardrails.

Program execution can be blocked or altered when a chamber's remaining volume falls below a threshold recorded after the hub fill, protecting the schedule and preventing dry-run conditions.

Fill verification may include reading a checksum or signature over composition, levels, and timestamp and syncing a Fill Session to an app/cloud record.

In a no-pod-memory variant, a signed composition record for a just-filled pod is transferred from the hub to the control body over a contactless channel (e.g., NFC, BLE, or inductive sideband) and bound to a pod identifier, enabling device operation without on-pod write-back.

Reservoir runout can be predicted from historical Fill Sessions and puff telemetry; when a threshold is met, the system can prompt the user and trigger an auto-reorder through the app.

Software modules stored on a non-transitory medium can implement device pairing, a blend-builder UI, program selection (recreation/reduction), fill orchestration and verification, computation of per-puff modulation targets, and related ecosystem functions.

The instruction set can further include perceived-density compensation from draw telemetry, habit-taper enforcement, inventory prediction and auto-reorder, and find-my-device signaling coordinated with the control body's speaker/LEDs.

In some embodiments, the application transmits signed composition records to the control body via NFC, BLE, or a wireless-charging coil sideband as an alternative to on-pod persistence.

The same software can orchestrate remote fills at a networked station that writes composition/levels prior to shipment, using the shared data model employed for personal fills.

A closed-loop fill sequence can include receiving chamber ratios/program via the app; computing a fill recipe; commanding the hub to execute a multi-source fill; verifying composition/levels via checksum; logging reservoir dispense events; and rendering on-hub LEDs that visualize programmed ratios.

When a content-class transition is detected, the system may require a purge or rinse routine before enabling the fill, with policy behavior keyed to jurisdictional flags.

The fill recipe can optionally specify oscillated valve actuation during a single pass to promote mixture uniformity.

An analytics/journaling loop can record puff count, session duration, chamber ratios, and derived strength; prompt user journaling at milestones; and adjust future reduction steps or recreation presets using the collected analytics.

The system treats resistive (PWM-driven) and ultrasonic (frequency/amplitude envelopes) atomization as interchangeable modulation channels for per-chamber delivery, allowing the application and device to execute programs with either or both modalities.

Each reservoir's on-module memory can include a reduction_set_id and a role (high-strength or low-strength). During a fill, the hub maps roles to pod chambers and persists a record identifying C_{H}, C_{L}, and the chamber map.

Delivered strength per puff can be computed as Cₘᵢₓ(t)=r_{H}(t)C_{H}+(1−r_{H}(t))C_{L}, with the controller modulating channel outputs to realize Cₘᵢₓ(t) while maintaining perceived density using draw telemetry.

The control body can enforce a monotonic reduction schedule with a bounded micro-step size (e.g. ≤3% absolute per session/day), apply smoothing between steps, and roll back when the user reports discomfort.

Per-puff control may alternate micro-bursts between channels using N time windows inside one puff to implement the commanded r_{H}(t).

The device can freeze a reduction program if persisted C_{H} and C_{L} do not match the expected reduction set, or when a chamber's remaining volume falls below a threshold; operation resumes upon refill or user override subject to policy.

Additional variants-verification-only handshake and non-pod-memory paths. The disclosure includes implementations where composition/level data are stored off-pod and verified at use time, along with single-channel program variants summarized below.

In a verification-only ecosystem, the refill hub writes a composition record to a non-pod data store (e.g., control body memory). When a pod is inserted, the control body verifies a pod identifier against the stored record (no composition parameters are accepted from the pod) and then modulates aerosol output according to the verified record.

The handshake may include reading a pod UID and verifying a signature or checksum over the UID/timestamp in the composition record; upon mismatch, the device can freeze or refuse operation. (Integrity fields and verification are described with the Reduction Composition Record and post-fill verify steps.)

After a fill, the hub can write the signed composition record directly to control body memory over a contactless link—e.g., NFC, BLE, or an inductive sideband—while the control body is positioned in the hub's charge/data cradle.

A representative composition record includes at least {pod_uid; volumes_ml; chamber_map (or logical channel map); policy_bits; signature/CRC} to support use-time verification and guardrails.

Responsive to a verified record, the control body can deliver mixtures using either proportional simultaneous drive or alternating micro-burst windows within a puff, while logging usage against the verified record.

A device implementation for the verification-only path provides a memory interface to a non-pod data store, performs a verification-only handshake with the inserted pod to confirm identity, and drives at least one atomization per the stored record with a lockout on verification failure.

A refill apparatus (hub) variant writes a signed composition record directly to a control body at fill completion while omitting any write of composition/level parameters to the pod, supporting the non-pod-memory flow. (See FIG. 23 handoff paths.)

A pod variant provides at least one liquid chamber, a refill interface, and a positive-pressure vent; in this variant the pod omits any on-pod writable memory for per-chamber composition or level, and the system instead retrieves composition/level data from a non-pod data store. At use time the control body performs a verification-only handshake in which it reads a pod identifier and authorizes operation solely upon matching that identifier to the stored composition record.

A single-channel program variant includes a hub that co-delivers multiple sources into a single chamber to achieve a target composition, a control body with one atomization channel, and an application that orchestrates sequential fills with bounded steps. The control body does not vary composition per puff but can enforce density compensation, daily budget, and usage logging bound to the last-fill composition record.

In that single-channel flow, the bounded composition change per fill can be set at ≤3% absolute, with optional rollback based on user-reported discomfort and analytics.

A corresponding method executes a series of fills that set single-chamber composition according to a bounded-step schedule; a signed composition record is persisted external to the pod; and, upon pod insertion, the control body verifies the pod identifier and operates one atomization channel without per-puff composition modulation.

A non-transitory program product can implement: receipt of fill inputs; orchestration of multi-source fill; generation and signing of a composition record bound to a pod UID; contactless transfer of the record to control body memory; and enforcement of a rule that the device accepts no composition parameters from the pod and locks out upon identifier mismatch.

A remote filling system may perform single-pass co-delivery into at least one pod chamber, create a signed composition record bound to the pod UID, and store the record to a user-associated control body or account prior to shipment, omitting composition writes to the pod.

A matched pair of reservoirs can constitute a reduction set: each module's memory advertises a common reduction_set_id and a role (high, low, or zero). The hub recognizes the pair, co-delivers into the pod, and persists resulting compositions to a non-pod data store for later verification.

### BRIEF DESCRIPTION OF THE DRAWINGS

The present disclosure is described in the detailed description which follows, in reference to the noted plurality of drawings by way of non-limiting examples of exemplary embodiments of the present disclosure.

FIG. 1 shows a control body and multi-chamber pod in accordance with aspects of the present disclosure.

FIG. 2 shows a partial cutaway view of the control body and multi-chamber pod shown in FIG. 1 in accordance with aspects of the present disclosure.

FIG. 3 shows a cutaway view of the control body and multi-chamber pod shown in FIG. 1 in accordance with aspects of the present disclosure.

FIG. 4 shows a partially enlarged isometric view of the control body and multi-chamber pod shown in FIG. 3 in accordance with aspects of the present disclosure.

FIG. 5 shows an isometric view of a modular multi-chamber pod assembly of the control body shown in FIGS. 1, 3 and 4 in accordance with aspects of the present disclosure.

FIG. 6 shows a second aspect section view of a multi-chamber pod assembly.

FIG. 7 shows a partial cutaway view of the multi-chamber pod assembly, showing a potential configuration for incorporating additional chambers beyond two chambers.

FIG. 8 shows a top view of a cup used in the control body in accordance with aspects of the present disclosure. (The cup may be described as a fluid guard.)

FIG. 9 shows coils or atomizers and a flash memory module of the multi-chamber pod assembly, electrically connected to pins extending from the daughterboard through the cup in accordance with aspects of the present disclosure.

FIG. 10 shows a control system and components of the control body in accordance with aspects of the present disclosure.

FIG. 11 shows an isometric view of the main electronics assembly of the control body contacting the flash memory module within the multi-chamber pod, facilitating data exchange and synchronization between the multi-chamber pod and the control body.

FIG. 12 shows a first aspect of an integrated multi-chamber fluid delivery system, comprising the control body, the hub, and the multi-chamber pods. The figure shows the control body docked within the hub, with additional pods also seated on the station for filling. The system is designed to automate the filling process and enable precise control over substance mixtures, illustrating the seamless interaction between the components.

FIG. 13 shows a perspective view of the connections between the reservoirs of the automated pod filling station (hub) and the multi-chamber pods, illustrating the possible implementation of the fluid transfer pathways that enable automated filling of the pods from the reservoirs.

FIG. 14 shows a first aspect of a bottom-up view of the connections between the automated pod filling station (hub) and the multi-chamber pods, as shown in FIG. 13 in accordance with aspects of the present disclosure.

FIG. 15 shows a second aspect of the automated pod filling station (hub) in an unloaded state in accordance with aspects of the present disclosure.

FIG. 16 shows a second aspect of the automated pod filling station (hub) with axially loaded modular (replaceable) reservoirs docked in slots as shown in FIG. 14. in accordance with aspects of the present disclosure.

FIG. 17 shows an underside view of the hub with the bottom panel removed in accordance with aspects of the present disclosure.

FIG. 18 shows an isolated view of the hub's fluidic conveyance assembly in accordance with aspects of the present disclosure.

FIG. 19 is an exploded perspective of a reservoir module configured for a vertical load docking axis; a functionally equivalent alternative embodiment to the axially loaded reservoirs shown in FIG. 16 in accordance with aspects of the present disclosure.

FIG. 20 shows the hub loaded and in use with a multi-chamber pod docked at a fill section and a pod inserted into the control body positioned at the charge/data cradle in accordance with aspects of the present disclosure.

FIG. 21 is a perspective view of a manufacturer-side (remote) filling station (hub) configured to prepare multi-chamber pods for shipment.

FIG. 22 is a flow diagram of a user-level hub fill process for a multi-chamber pod, showing detection, input acquisition, device-state read, recipe/policy decision, fluid transfer, persistence, and finalization.

FIG. 23 is a block diagram of memory handoff with redundant paths, illustrating representative profile/recipe sources and alternative write/read interfaces between the hub, pod, and control body.

FIG. 24 is a state-machine diagram of the hub's fill workflow for a multi-chamber pod, depicting detection and state acquisition, reservoir read, ratio/target selection, policy check with optional purge, pump actuation, stop at volume/time with memory update, verification/logging, and synchronization to leave ready.

FIG. 25 is a process flow for the reduction program, illustrating reservoir role handshake, single-pass co-fill to establish chamber strengths, persistence of a composition record, selection of a reduction schedule, derivation of per-puff mixture targets, and dual-channel actuation modes.

FIG. 26 is a timing diagram showing an example micro-burst implementation within a puff, with time-window assignments between high-strength and low-strength channels.

FIG. 27 is a flow diagram of a remote fulfillment method in which user data drives pod configuration at a business-operated filling station; the method parallels the personal hub workflow while differing in implementation context.

FIG. 28 is an illustrative architecture of a computing system implemented in embodiments of the present disclosure.

### DETAILED DESCRIPTION

The present disclosure relates to a vaping device and, more particularly, to a multi-chamber delivery device and methods of use. More specifically, the multi-chamber delivery device may be an electronic vaping device engineered to reduce substance concentrations imperceptibly over time. For example, the electronic vaping device comprises multiple chambers which accommodate different substance concentrations. The electronic vaping device employs power modulation techniques, such as pulse width modulation (PWM), to control vaporization and deliver a progressively decreasing substance dosage, imperceptible to the user. This broad categorization includes, but is not limited to, the manipulation of voltage, current, or duty cycle to achieve the desired control over substance delivery, thereby assisting users in reducing substance dependency. Accordingly, and advantageously, the substance delivery system described herein, e.g., electronic vaping device, will assist users in reducing substance dependency.

In more specific embodiments, the electronic vaping device comprises two separate fluid chambers, each containing, for example, any known type of e-fluid (including, but not limited, to nicotine fluid) with differing concentrations. For example, the present invention contemplates using a substance containing liquid with different concentrations. Integrated within each chamber is a dedicated coil responsible for vaporizing the chamber's contents. The electronic vaping device uses independently controlled pulse width modulation circuitry for each fluid chamber. In this way, the independently controlled pulse width modulation circuitry individually and discretely controls the vapor production from each coil, allowing for precise manipulation of the vapor mix from the two separate chambers. The electronic vaping device may also be used with other product types such as, e.g., marijuana reduction programs.

In use, for example, upon activation, the electronic vaping device simultaneously vaporizes the contents of both fluid chambers. Due to the independently controlled pulse width modulation circuitry, one chamber's vapor production dominates initially, with the second chamber contributing a lesser amount. Over time, the ratios are gradually adjusted, reducing the dominance of a higher substance concentration chamber to a lower substance concentration chamber in the vapor mixture. The intended usage cycle spans over a predetermined time-period over which the settings of the power modulation circuitry may be adjusted according to a predetermined schedule. This schedule is designed to reduce the substance dose incrementally such that the user experiences a seamless transition to lower substance intake levels without acute awareness of the change. In this way, the electronic vaping device revolutionizes substance reduction by providing a user friendly, discreet, and gradual method of reducing substance dependency

In an illustrative example, which is not to be considered a limiting feature, the present system may use a progressive pod system (with two chambers filled with the e-fluid) in which the first pod will be comprised of 50 mg/ml or other standard dosage for the user is in both chambers of the pod as noted in an evaluation period. Once evaluated, a step-down plan may be initiated in which the pod will comprise one chamber containing baseline dosage and a second chamber comprising a decreased dosage. The next pod in the system will then begin with the previous lower dosage and its successive decreased dosage in the second chamber. This pattern will continue until Omg/ml dosage is reached. Exact schedule dates are subject to change.

### Reference Characters

Like reference numerals refer to like elements throughout the figures. Primes (′, ″) indicate alternative embodiments of the same element. Unless the context clearly indicates otherwise, a reference to a base numeral includes its primed counterparts (e.g., 12 includes 12′ and 12″). For example, “coils 18a, 18b” correspond to 18a′/18b′ (pod 12′) where shown.

### Conventions—Terminology and Memory Hand-Off

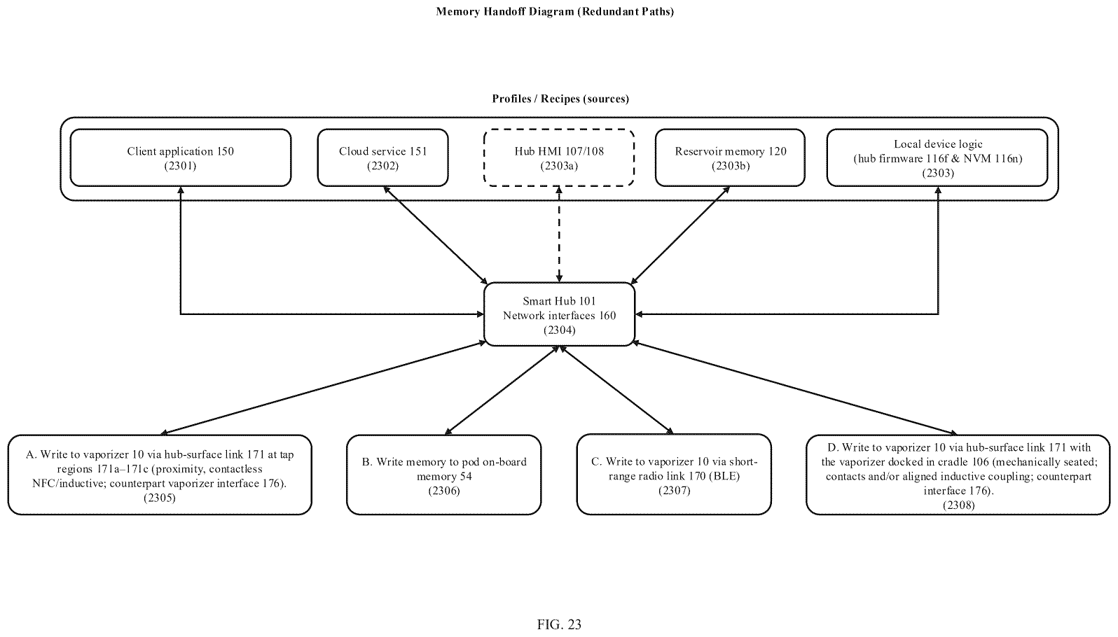

As used herein, “control body 10” (also referred to in some figures as the vaporizer or adaptive control body) denotes the handheld device; “hub 101” (also called the personal docking/refilling station) denotes the stationary unit. Unless expressly stated otherwise, any reference to “writing to memory,” “persisting a record,” or “reading back state” encompasses any one or more of the redundant paths described with respect to FIG. 23, including on-pod memory 54, control-body memory via short-range radio 170, proximity hub-surface link 171 (tap regions and/or cradle 106), and synchronized app/cloud storage accessible via hub interfaces 160. The same physical/logical interface may be used for write and read-back. Ordering among these operations is non-limiting, and any subset may be used. Where a particular paragraph below mentions a single path (e.g., on-pod memory 54) the comparable operation may be performed over any other available path(s) without departing from this disclosure.

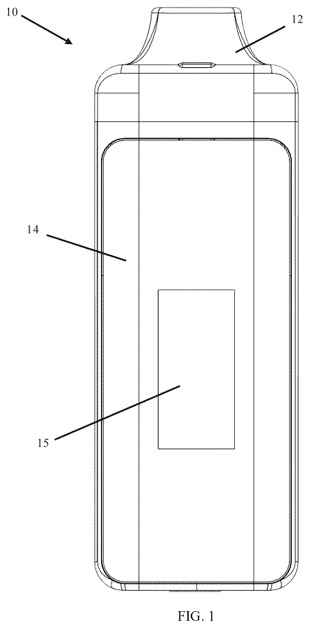

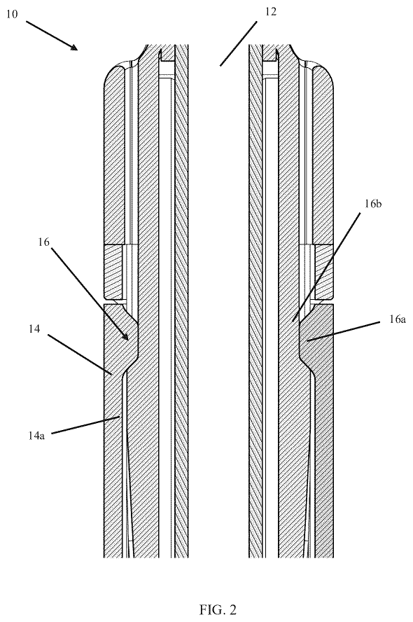

FIG. 1 shows a control body in accordance with aspects of the present disclosure. The control body 10 may include an assembly comprising a modular multi-chamber assembly (cartridge pod) 12 and a main housing (e.g., main body) 14. In embodiments, the modular multi-chamber assembly 12 may be a disposable assembly which is fitted to the main housing 14 and, more particularly, the modular multi-chamber assembly 12 may snap fit into the main housing 14 using, for example, a resilient or flexible tab fitting mechanism 16 as shown in more detail in FIG. 2. The modular multi-chamber assembly 12 and the main housing 14 may be composed of any material that is resilient to heat and/or vaporized fluids. For example, the modular multi-chamber assembly 12 and the main housing 14 may be composed of plastic materials, e.g., polycarbonate, polypropylene, etc., carbon fiber material, amongst other materials, alone or in combination, and functional equivalents thereof. In some embodiments, the modular multi-chamber assembly 12 further provides electrical and/or contactless data interfaces (e.g., spring contacts and/or a short-range link) so that device 10 can exchange per-chamber composition/level data with the pod's non-volatile memory 54 and with a personal hub as described elsewhere; references herein to persisting or reading a “record” are intended to encompass any of the redundant memory handoff paths described with respect to FIG. 23 (without limitation to a particular transport).

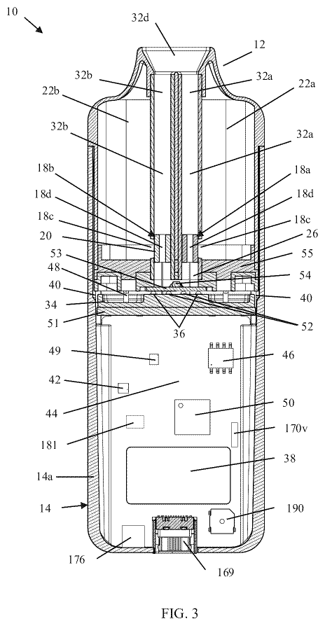

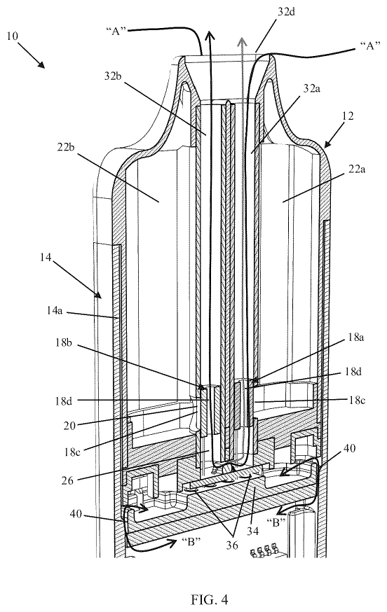

In embodiments and as described in more detail with respect to at least FIGS. 3 and 4, the modular multi-chamber assembly 12 comprises a passageway allowing the user to inhale vaporized product, e.g., aerosol containing substance, from multi-chambers accommodating different substance concentrations. The modular multi-chamber assembly 12 may include an assembly comprising the coils or atomizers, the dual fluid chambers (cartridges) and dual passageways leading from the fluid chambers to a mouthpiece as described in more detail herein with respect to FIGS. 3 and 4. The entire assembly of the modular multi-chamber assembly 12 may be removable from the main housing 14 and, in embodiments, is a replaceable assembly upon the fluid within the fluid chambers being consumed. In other embodiments, additional chambers (e.g., a four-chamber variant) and/or a mixing region may be provided, the foregoing features being applied mutatis mutandis. In some embodiments, the modular multi-chamber assembly 12 also incorporates self-sealing refill interfaces configured to mate with a filling hub, thereby permitting automated filling/adjustment while preserving the same user-replaceable form factor.

The main housing 14, on the other hand, houses the electronic components such as the battery and circuitry, e.g., pulse width modulation circuitry, in addition to a pressure sensor, amongst other features. The main housing 14 may also include a display 15. The display 15 may be an LCD screen, OLED screen, TFT screen, etc. The display 15 may provide information to the user including, for example, an amount of fluid remaining in the chamber, usage information, or other statistic information, etc. In further embodiments, display 15 may act as a user interface configured to receive user input and adjust the predetermined time period for activation of each coil 18a, 18b, according to the user input. In addition, the combination of the modular multi-chamber assembly 12 and the main housing 14 may form a seamless air-intake passageway, leading from an exterior of the main housing 14 to the outlet (e.g., mouthpiece) of the modular multi-chamber assembly 12 as further described herein. In some embodiments, the electronics within housing 14 further include a microcontroller, voltage regulation, and gate-drive stages that implement the power-modulation envelopes used to control per-chamber atomizers, and local logic that can read and/or write a composition/level record to the pod and/or to an external hub via wired, contactless, or radio links as later described. The UI may, in embodiments, render per-chamber indicators or blend ratios and accept profile selections consistent with the profiles/recipes discussed elsewhere in this specification.

FIG. 2 shows a partial cutaway view of the control body 10 shown in FIG. 1. In particular, the partial cutaway view shows a partial view of the modular multi-chamber assembly 12 and the main housing 14 fitted together with a tab fitting mechanism 16. In embodiments, the modular multi-chamber assembly 12 may fit within the main housing 14 using a friction fitting between respective sidewalls. In embodiments, the sidewall 14a of the main housing 14 may be composed of a material that is flexible and resilient such that the modular multi-chamber assembly 12 may be fitted within the sidewall 14a of the main housing 14. For example, the sidewall 14a of the main housing 14 may be composed of plastic materials, e.g., polycarbonate, polypropylene, etc., carbon fiber material, metal materials and metal alloys, amongst other materials. Stainless Steel Tubes may make up part of the chamber. They can provide mechanical separation between air passageways and fluid chamber as well as act as a heatsink and mount for the coils

As shown in FIG. 2, the tab fitting mechanism 16 includes a protuberance or tab 16a extending from an interior of the sidewall 16a of the main housing 14. The modular multi-chamber assembly 12 may have a corresponding indentation 16b aligning with the protuberance or tab 16a and formed in an interior of the sidewall of the modular multi-chamber assembly 12. In embodiments, the protuberance or tab 16a fits into (e.g., snaps into) the corresponding indentation 16b to lock the modular multi-chamber assembly 12 to the main housing 14, e.g., when the modular multi-chamber assembly 12 is seated (slid) into the main housing 14. In embodiments, the protuberance or tab 16a and corresponding indentation 16b may be an annular protuberance or tab 16a and indentation 16b, e.g., provided around the circumference of the main housing 14 and the modular multi-chamber assembly 12, or provided in different locations around the main housing 14 and the modular multi-chamber assembly 12.

FIG. 3 shows a cutaway view of the control body 10 shown in FIG. 1. As shown in this view, the modular multi-chamber assembly 12 includes two heating coils or atomizers (hereinafter referred to as “coils”) 18a, 18b with respective wicking openings 18c leading to respective hollow interior passageways or vapor conduits 18d of the respective coils 18a, 18b. In embodiments, the coils 18a, 18b can be any combination of high resistance coils (e.g., 1 ohm and above) and low resistance coils (e.g., below 1 ohm) used in electronic vaping devices as is known in the art such that no further explanation is required for a complete understanding of the present invention. As is known in the art, the wicking openings 18c are covered with a wicking or absorbent material 20, e.g., cotton or other wicking material. In this way, the absorbent material 20 will wick the fluid within respective fluid chambers 22a, 22b which, in turn, can be heated by the coils 18a, 18b, resulting in a vapor comprising different concentrations of substance.

The two coils 18a, 18b are surrounded by the respective fluid chambers 22a, 22b, each of which accommodate different substance concentrations. The vaporization or aerosolization of the different substance concentrations are controlled independently by the coils 18a, 18b. In embodiments, the outer wall of each of the coils 18a, 18b will form part of the respective fluid chambers 22a, 22b and, hence, are integrally formed cartridges. The coils 18a, 18b and respective fluid chambers 22a, 22b are an integral assembly and may be disposed of and replaced with another modular multi-chamber assembly 12 (e.g., mouthpiece assembly) upon the consumption of the fluid within the respective fluid chambers 22a, 22b.

Still referring to FIG. 3, the coils 18a, 18b are sealed to the modular multi-chamber assembly 12. A singular silicone sleeve may seal the pod, allowing for easy assembly and filling. The silicone sleeve may fit tightly to the pod housing and stainless-steel tubes. The coils are sealed through a tight fit inside the stainless-steel tubes, as an example. In embodiments, seals e.g., O-rings, may also be contemplated herein at a top and bottom of the modular multi-chamber assembly 12. For example, seals can surround the coils 18a, 18b and are press fitted against sidewalls 12a of the modular multi-chamber assembly 12. In this way, the seals can seal the coils 18a, 18b in an airtight and fluid tight manner against the sidewalls 12a of the modular multi-chamber assembly 12 to prevent fluid from leaking from the respective fluid chambers 22a, 22b into the air passageways, etc.

As further shown in FIG. 3, a fluid and airtight passageway 26 around each of the coils 18a, 18b, leading to the hollow interior passageways or vapor conduits 18d of the coils 18a, 18b. For example, the airtight passageways 26 may be an annular groove around the coils 18a, 18b and which communicates with an opening 18e at the bottom of the coils 18a, 18b. The openings 18e, in turn, are in fluid communication with the hollow interior passageways or vapor conduits 18d of the coils 18a, 18b. The passageways 26 also lead to respective air passageways 28 in fluid communication with openings 30 in the sidewall 14a of the main housing 14. The passageways 28 may be formed between the sidewalls of the modular multi-chamber assembly 12 and main housing 14.

At the upper end of the coils 18a, 18b are dual passageways 32a, 32b in fluid communication with the respective hollow interior passageways or vapor conduits 18d of the coils 18a, 18b. In embodiments, there is no need for a mixing chamber as the fluid will mix automatically once inhaled. In alternative embodiments, the dual passageways 32a, 32b can also merge together to form a mixing chamber where the vapor with different substance concentrations from the different respective fluid chambers 22a, 22b are mixed. The mixed vapor is then drawn through an outlet (mouthpiece) 32d of the modular multi-chamber assembly 12. In this way, upon a user inhaling into the control body 10, air can be drawn through the opening 30, into the passageways 28, through the respective hollow interior passageways or vapor conduits 18d (which is now vapor containing substance), and into the mixing chamber 32c where the different concentrations of substance are mixed, and thereafter drawn through the outlet of the modular multi-chamber assembly 12. Accordingly, the vaporized fluid from each of the fluid chambers 22a, 22b (with different substance concentrations) can be delivered in different doses by independently controlling each of the coils 18a, 18b. It should also be understood by those of skill in the art that as the coils 18a, 18b are independently controlled, the vapor from heating any combination of the fluid in the different respective fluid chambers 22a, 22b can be consumed.

Accordingly, in reference to FIG. 3, the modular multi-chamber assembly 12 incorporates the coils 18a, 18b which are secured within the assembly to prevent any leakage of fluid from the fluid chambers 22a, 22b into the air passageways. To achieve this, a press fit of stainless-steel tubes into a molded portion of the pod. In further embodiments, one or more seals, e.g., top O-ring, may be positioned with respect to the modular multi-chamber assembly 12. These seals ensure that the coils are maintained in an airtight and liquid-tight condition against the sidewalls 12a of the modular multi-chamber assembly.

It should be noted that while the present design facilitates the securement of the coils via seals, this configuration does not preclude alternative embodiments in which the coils are permanently integrated into the assembly. Such an integration enhances the leak-proof capabilities of the control body by eliminating the need for separate sealing components, thereby simplifying the manufacturing process and potentially improving control body reliability. Accordingly, it should be understood by those of skill in the art that FIG. 3 covers both configurations: one where the coils are sealed into the assembly using removable components such as O-rings, and another where the coils are an integral part of the pod structure, crafted to be non-removable and seamlessly integrated within the pod's material composition, without departing from the spirit and scope of the invention.

FIG. 3 further shows a cup 34 (e.g., daughterboard) which is press fitted into the main housing 14. The cup 34 may act as a stop mechanism to ensure that the modular multi-chamber assembly 12 properly sits within the main housing 14. In other words, the cup 34 ensures that the mouthpiece is not over inserted into the main housing 14. The cup 34 may also include pins 48. The cup 34 and pins 48 may also provide additional rigidity and strength to the main housing 14. The system described herein performs these functions and provides structure and protection for the daughterboard, features divots for capturing leaked fluid, facilitates communication with both the flash memory 54 and coils 18a, 18b, of the pod, and allow light from the LEDs 56a, and 56b to passthrough to the pod for illumination.

The cup 34 includes a plurality of pins 36 which electrically connect to the underside of the coils 18a, 18b. The plurality of pins 36 are also electrically connected to a battery 38, housed within the main housing 14. In this way, upon activation of the control body 10, the plurality of pins 36 provide a charge (e.g., voltage) to the coils 18a, 18 which will effectively raise the temperature of the coils 18a, 18b (e.g., heats up the coils) to vaporize the fluid in the respective fluid chambers 22a, 22b (with different substances and or concentrations).

A plurality of openings 40 or a gap is formed between the “cup” and the side wall of the housing, communicating with the air passageways 28 and an interior portion of the main housing 14. This opening 40 will allow air to pass into the main housing 14, where a pressure sensor 42 is provided on a circuit board 44. The pressure sensor 42 in the main housing 14 will sense a pressure differential upon a user inhaling on the control body 10. The pressure differential may be used to activate the control body 10, e.g., to begin charging (e.g., applying voltage) the coils 18a, 18b to vaporize the fluid in the respective fluid chambers 22a, 22b. The circuit board 44 may also include a power modulation module, e.g., pulse width modulator circuitry, 46 to control individually and discretely each of the respective coils 18a, 18b. This independent control of the coils 18a, 18b will allow precise manipulation of the vapor mix from the two separate fluid chambers 22a, 22b.

FIG. 4 shows a partially enlarged isometric view of the control body 10 shown in FIG. 3. This view more clearly shows the full airway passageway from the opening 40 to the outlet (e.g., mouthpiece) 32d of the modular multi-chamber assembly 12 as depicted by the arrow labeled “A”. In addition, this view more clearly shows the full airway passageway through the opening 40 of the cup 34 into the interior portion of the main housing 14 in order to allow the pressure sensor 42 to sense a pressure differential upon the inhalation of the user, as depicted by the arrow labeled “B”. Moreover, the respective fluid chambers 22a, 22b and respective passages 32a, 32b, 32c, 32d are integrally formed with the housing (e.g., modular multi-chamber assembly 12).

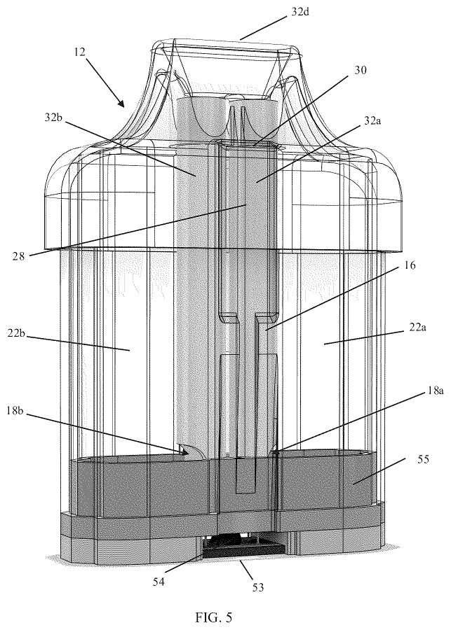

FIG. 5 shows an isometric view of a modular multi-chamber assembly 12 shown in FIGS. 1, 3 and 4. As shown in this view, the modular multi-chamber assembly 12 is a modular assembly comprising the coils 18a, 18b and the respective fluid chambers 22a, 22b, in addition to the dual passageways 32a, 32b in fluid communication with the respective hollow interior passageways or vapor conduits of the coils 18a, 18b, the mixing chamber 32c and the outlet 32d. As the modular multi-chamber assembly 12 is a disposable unit, it may be replaced with a new modular multi-chamber assembly 12 after the fluid in the respective fluid chambers 22a, 22b has been consumed, or the modular multi-chamber assembly has exceeded its refill limit. The assembly also incorporates a specialized interface on its base 127a, 127b that connects to the hub 101. This interface allows for automated filling, refilling, and fluid withdrawal operations. Possible implementations for this interface include one or more valve-coupling mechanisms, self-sealing ports, magnetic fluid couplers, or quick-connect fittings. These features ensure secure and precise transfer of fluids into or out of chambers 22a, 22b during interaction with the hub 101, which can manage the refilling or removal of liquids based on user preferences or system-defined parameters.

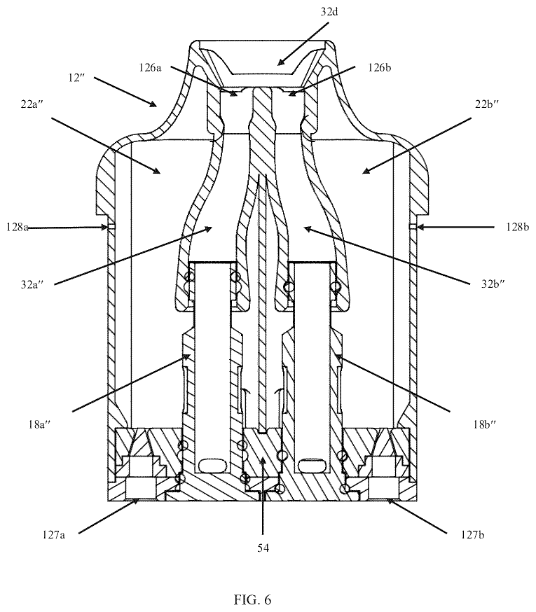

### FIG. 6: Dual-Chamber Pod (Section View)

The pod 12″ includes separate left/right chambers 32a″, 32b″ each feeding an associated atomizer 18a″, 18b″. Atomizers can be resistive heaters (e.g., Fe—Cr—Al coils) driven by PWM or ultrasonic transducers; hybrid combinations are contemplated. Outlets 126a, 126b lead toward a mixing region or directly to the mouthpiece 32d, with anti-spit back geometry in the airflow path. Refill interlocks/inlets 127a, 127b mate to hub junctions 105a, 105b and remain sealed unless engaged by the hub; displaced gas exits through positive-pressure vents 128a, 128b and may be routed to an external or closed-loop return to pump inlet 110b. Pod memory 54 stores per-chamber composition and levels that may be written by the hub after a fill, as well as optional atomizer IDs and drive envelopes (limits) used by the control body to bound power. The multi-chamber design allows each chamber to contain fluids with varying concentrations of nicotine, THC, CBD, among other substances, with the modulation techniques ensuring accurate control over the vapor mix produced by the different chambers.

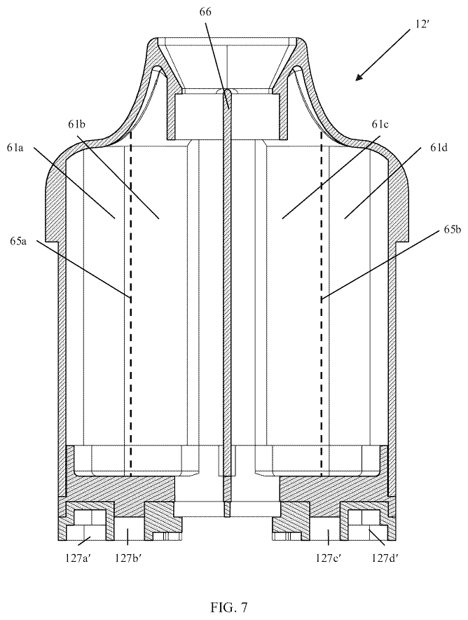

FIG. 7 is a partial cutaway/section of a multi-chamber pod variant 12′ in which the left and right liquid cavities are sub-divided to provide four hydraulically isolated chambers 61a, 61b, 61c, and 61d. In the illustrated orientation, an outer-left chamber 61a and an inner-left chamber 61b lie on one side of a central spine, and an inner-right chamber 61c and an outer-right chamber 61d lie on the opposite side. Divider structures 65a and 65b (shown schematically with dashed partition lines) define the sub-chambers and can be realized as integrally molded webs, bonded inserts, or equivalent divider structures that extend generally along the pod height (full-height or partial) to hydraulically isolate the chambers. A central stem/manifold feature 66 is shown at the upper region. In this four-chamber variant, the pod further provides four self-sealing refill interfaces 127a′, 127b′, 127c′, and 127d′ positioned at the base, configured to mate with corresponding hub couplers—functionally analogous to the refill interlocks/inlets described for the two-chamber embodiment of FIG. 6.

Except as otherwise noted, the fluidic, electrical, and control features disclosed for the two-chamber embodiments apply to the four-chamber embodiment mutatis mutandis. In some embodiments, each chamber is associated with a respective atomization element—for example, a resistive heater (coil) and wick, an ultrasonic transducer, or a mixed modality—and the control body drives the elements independently in accordance with per-chamber targets (e.g., composition and/or output envelope) previously persisted after a hub fill. To the extent required by the implementation, corresponding feed paths, vents, and data interfaces can be replicated and addressed on a per-chamber basis, and the hub's reservoir-to-chamber mapping, policy gating, and memory-handoff semantics disclosed elsewhere herein are applicable to address any subset or all of chambers 61a-61d during a fill.

Directional terms such as “left,” “right,” and “vertical” are used with respect to the illustrated orientation for convenience and are not limiting. Numerals 61a-61d identify chamber volumes, numerals 65a and 65b identify partition structures, and numerals 127a′-127d′ identify refill interfaces in this alternate embodiment (corresponding to the refill interfaces identified in FIG. 6 without limitation). Other structural features shown but not numeraled can be implemented in functionally equivalent ways consistent with this disclosure.

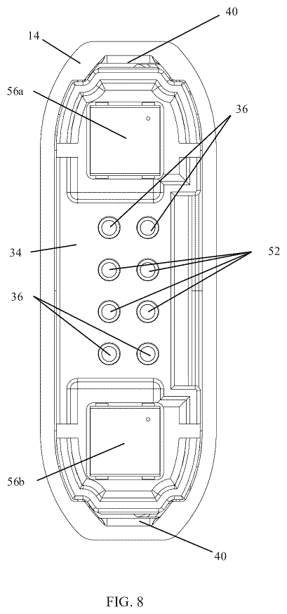

FIG. 8 shows a top view of the cup 34. The cup defines a recessed, perimeter-walled region that (i) aligns and mechanically stops the pod relative to the control body 14, and (ii) functions as a fluid guard to isolate the main electronics from condensate or incidental liquid. In the illustrated build, air passages 40 are provided at the ends of the cup so that ambient airflow can communicate from the exterior into an internal pressure-sensing path (downstream circuitry not shown). In other embodiments, the airflow path is formed by a continuous peripheral gap between the housing and the cup wall, or by discrete apertures through the cup; hydrophobic mesh or baffles may be used.

The cup carries two contact arrays. A first array of spring-contact pins 36 mates to corresponding pads on the pod to drive and sense the atomization elements (e.g., per-chamber heater/transducer connections and returns). A second, centrally located array 52 provides a data/power interface to the pod's memory or other low-power circuitry (e.g., V+, ground, and a two-wire serial interface). Counts and assignments are implementation-dependent; by way of non-limiting example, the arrangement may include four contacts for coil/actuator drive and four contacts for memory/power. Contacts can be gold-plated, compliant-travel spring pins or equivalent resilient conductors with ESD-tolerant routing.

Status indicators are positioned so that light is visible through windows in the pod or housing. The LEDs 56a, 56b can illuminate the pod, indicate operating or pairing states, render per-chamber color cues or blend ratios, and support user prompts; alternative indicator placements and counts are contemplated.

In some variants the cup incorporates gutters, collars, or elastomeric overmold features to route and capture stray liquid away from the pins 36/52 and toward a drip or service area; seals can be provided at the cup-to-housing interface. Materials can include molded thermoplastics (e.g., PC/ABS, PBT) with optional LSR overmold; metal or composite inserts may be used for stiffness. The geometry and contact count shown are illustrative; functionally equivalent layouts, pin counts, or passage implementations may be substituted without departing from the disclosed semantics.

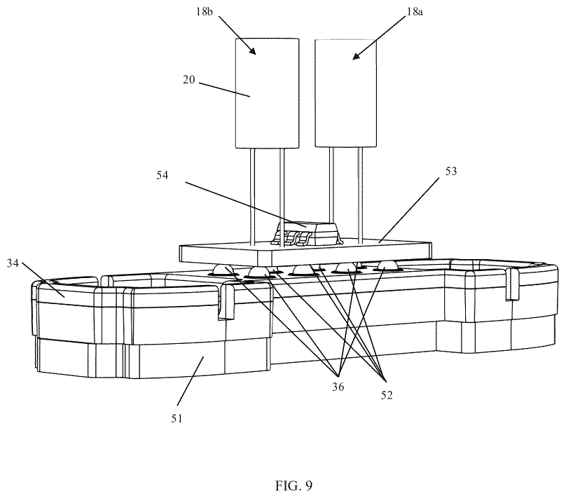

FIG. 9 illustrates the two atomization elements 18a and 18b electrically coupled to respective spring-contact pins 36 carried by the cup or daughterboard 34. In the depicted resistive implementation, each element includes wicking regions 18c communicating with an absorbent wick 20 so that liquid is drawn from its chamber into the heater; the wick is positioned proximate the chamber floor to minimize residual volume. In other embodiments one or both elements can be an ultrasonic transducer (with or without a supplemental wick), or a mixed-modality arrangement can be used; pin count and assignment at 36 are implementation-dependent.

The pod PCB 53 supports a non-volatile memory device 54 that stores pod-associated data (e.g., identifiers, per-chamber composition/level after a hub fill, optional drive limits, and integrity fields). A second contact array 52 provides the data/power interface between the control body and the pod PCB 53; the arrays 36 and 52 are shown as separate groups to illustrate that actuator drive and low-power memory/data signals can be routed independently. Counts, pinout, and protocol are not limiting; compliant spring pins or equivalent resilient conductors may be used, and contacts can be plated to withstand repeated insertions.

The cup 34 aligns the pod and shields the main electronics from condensate as described with respect to FIG. 8. In some builds, the cup incorporates gutters or collars that route incidental liquid away from contact regions 36/52 toward a drip or service area; optional meshes or baffles may be used in associated air passages. With the electrical interfaces established, the control body can independently drive 18a and 18b to implement per-chamber targets (e.g., PWM or ultrasonic envelopes) derived from a program and the composition/level data persisted after a hub-initiated fill, with verification and logging as disclosed elsewhere.

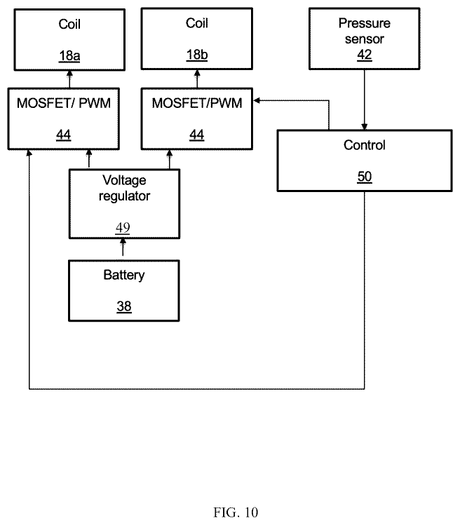

FIG. 10 shows a control system and components in accordance with aspects of the present disclosure. The control system includes, without limitation: a battery 38; a voltage regulator 49; a controller (microcontroller) 50; a pressure sensor 42; and power-modulation hardware that, in representative embodiments, comprises a pulse-width-modulation (PWM) module 46 (receiving control signals from the microcontroller) and gate-drive stages (e.g., MOSFET stages) that switch power to respective atomizers 18a and 18b. The voltage regulator 49 regulates the voltage from the battery 38 to the coils 18a, 18b and other circuitry. By way of example, the regulator is a component of the power supply that ensures a steady, constant supply through normal operating conditions, thereby supporting repeatable drive envelopes. The microcontroller 50 may directly control the MOSFETs by generating a square wave with the required duty cycles, and/or may issue commands to the discrete PWM module 46 which, in turn, drives the MOSFET stages.

In operation, the pressure sensor 42 senses pressure within the main housing 14. The microcontroller 50 evaluates the signal to distinguish user inhalation from non-activation events (e.g., air disturbance from driving/blowing in) and activates the control body 10 when an inhalation condition is met. Otherwise, non-activation events are ignored. In various embodiments the controller may apply thresholding and temporal filtering (e.g., debounce windows) so that activation is robust in common use environments.

Upon activation, the microcontroller 50 turns the MOSFET(s) on and off for different amounts of time (duty factors) in accordance with a desired or programmed substance concentration to be delivered to the user. The microcontroller 50 may be pre-programmed or user-programmed (e.g., via an application or companion interface) to select or modify these targets.

The PWM module 46 (and associated MOSFET stages) powers the coils 18a, 18b. With the assistance of the microcontroller 50, the device adjusts delivered concentration by independently switching the coils 18a, 18b which, in turn, vaporize liquid from respective fluid chambers 22a, 22b having different substance concentrations.

In some embodiments, the microcontroller 50 is programmed to adjust the on-time/off-time of coils 18a, 18b over successive puffs/sessions to imperceptibly reduce substance concentration. For example, the controller can command the PWM circuitry 46 such that the vaporization process delivers a progressively decreasing dosage by independently and discretely controlling vapor production from each coil 18a, 18b, thereby enabling precise manipulation of the vapor mix from the separate chambers 22a, 22b. Over time, the relative ratios of vapor from the different concentrations are gradually adjusted, decreasing the contribution of the higher-concentration chamber and increasing the contribution of the lower-concentration chamber.

Without limiting the foregoing, the controller 50 can enforce safety and quality constraints (e.g., soft-start, maximum duty-cycle limits, undervoltage/overcurrent lockout) and may, in variants, drive other atomization modalities (e.g., ultrasonic transducers) using functionally equivalent control signals. Signal partitioning among 46, the MOSFET stages, and 50 is implementation-dependent and does not limit the disclosed control semantics.

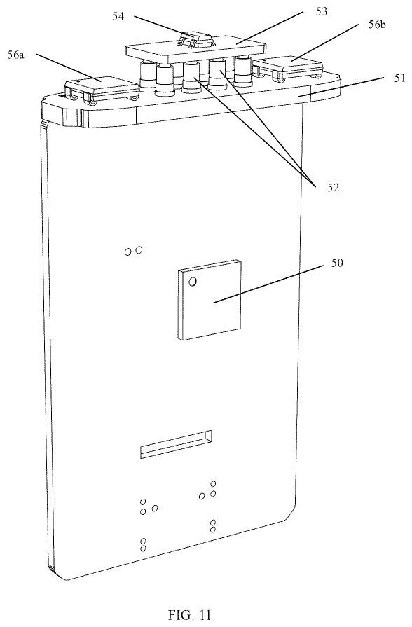

FIG. 11 is an isometric view of the main electronics assembly 51 of the control body. The assembly supports upward-facing spring-contact arrays 52 that, when a pod is seated, compress against pads on a pod PCB 53 carrying a non-volatile memory device 54. Through these contacts the controller 50 (mounted on the assembly) exchanges data with the pod—e.g., reading/writing composition/level records and related integrity fields—and, in other embodiments, provides actuator drive and low-power signals routed to the pod interface. Status indicator LEDs 56a and 56b are positioned to illuminate through pod 12 windows to render operating or pairing states. Contact count, pinout, and protocol are implementation-dependent; the layout shown is illustrative and functionally equivalent arrangements may be used.

### Overview of Filling Apparatus and Numbering.

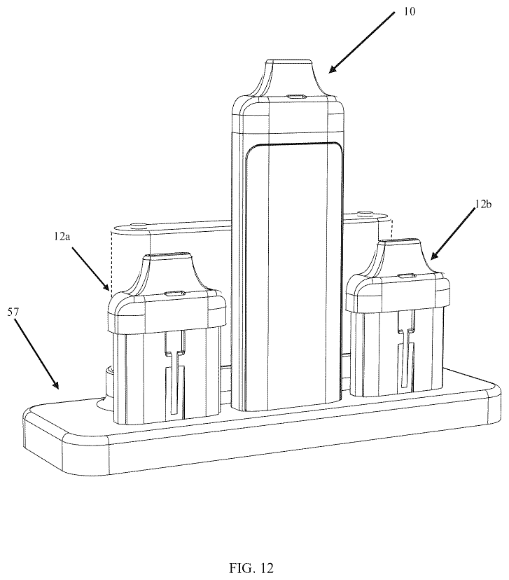

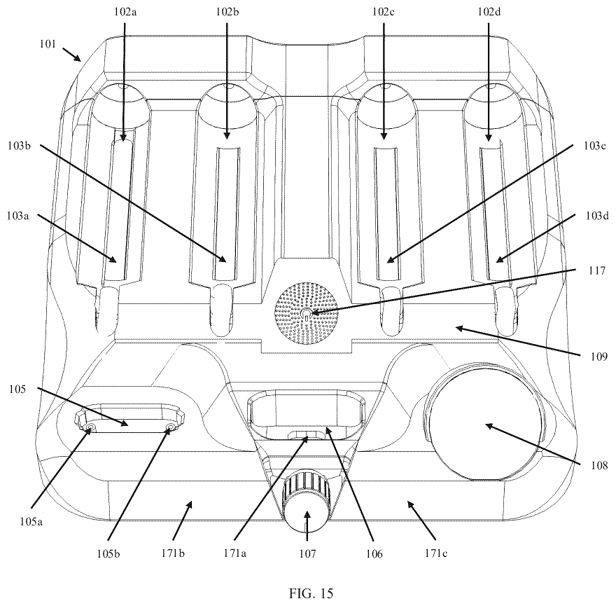

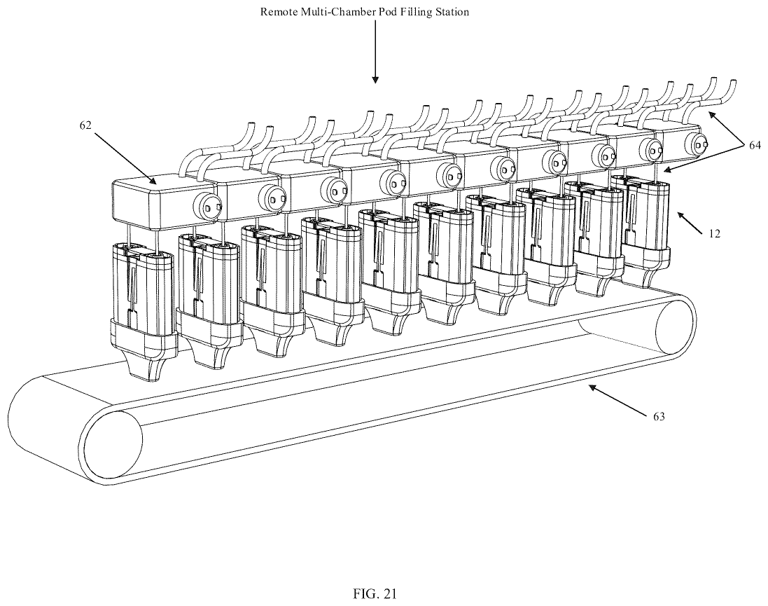

For continuity of disclosure, FIGS. 12-14 (a first aspect of a filling apparatus) and FIG. 21 (remote line) depict an earlier filling apparatus implementation suitable for automated transfer of liquid from one or more reservoirs to multi-chamber pods and/or to a control body 10. FIGS. 15-18 and 20 depict a refined, user-operated second aspect of a filling apparatus-herein also referred to as the “hub” 10

### FIG. 12 (A First Aspect of a System Perspective).

A perspective view of an integrated system showing a control body 10 centrally docked on a base 57 and two multi-chamber pods 12 seated for filling. This view illustrates the overall arrangement of the control body device 10, hub 101, and pods 12 as an automated filling environment.

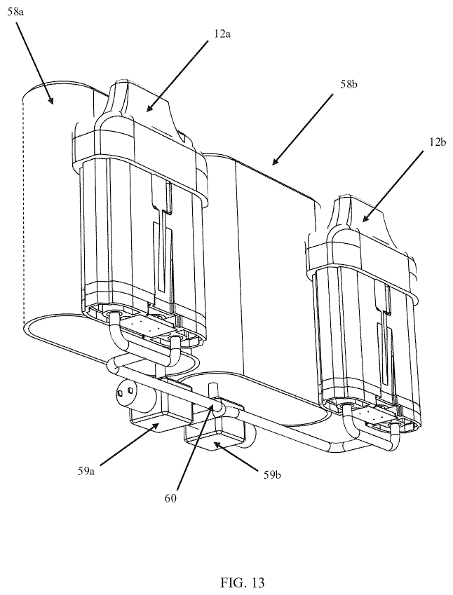

### FIG. 13 (A First Aspect of a Connections Perspective).

A perspective view from below showing fluid conveyance lines 60 coupled to pumps 59a, 59b to transfer liquid between reservoirs 58a, 58b and the pod interfaces. This view exemplifies positive-pressure transfer through quick-connect style couplings to execute automated, recipe-driven pod fills.

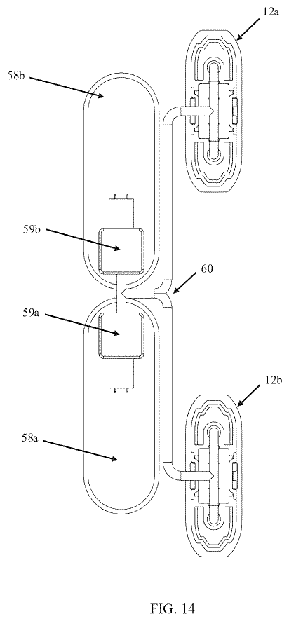

### FIG. 14 (A First Aspect of a Bottom-Up Schematic).

A bottom-up view of the same connection architecture shown in FIG. 13, again identifying reservoirs 58a, 58b, pumps 59a, 59b, and conveyance lines 60 as they couple to the multi-chamber pods 12a, 12b for automated filling.

### FIG. 15 (Hub-Unloaded State; Plan View).

FIG. 15 depicts an embodiment of a hub (101) in an unloaded condition. The hub 101 presents four reservoir slots 102a-102d arranged along the top surface. Each slot includes a slot indicator and memory interface 103a-103d that (i) renders status/role via an LED bar and (ii) establishes a read/write path to on-module reservoir memory 120 when a reservoir is docked. In some embodiments the interface comprises spring contacts to an EEPROM; other variants employ NFC or QR code scanning. The front deck includes the pod-fill section 105 with left-chamber junction 105a and right-chamber junction 105b, each configured to mate to a corresponding self-sealing coupler on the pod base (see FIG. 6, 127a/127b). A charge/data cradle 106 aligns a control body 10 for wired charging and/or contactless data handoff, while a rotary encoder 107 and display 108 provide local UI. One or more manual release lids 109 provide service access to liquid lines and drip-capture features for residual fluid cleanup. A speaker 117 may issue audio cues during filling and verification. In a typical usage model (non-limiting), slots 102a-102b are associated with the left-chamber feed 105a and slots 102c-102d with the right-chamber feed 105b, enabling pairwise blending into each chamber during a single pass; the controller can remap this association dynamically using the reservoirs' identities read at 103a-103d.

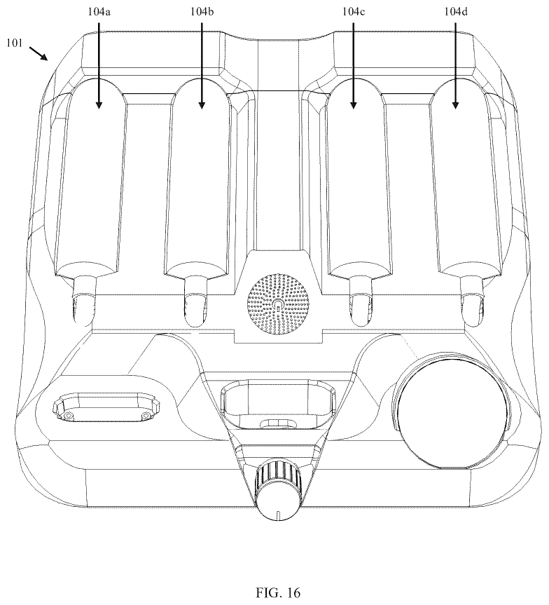

FIG. 16: Hub with Reservoirs Loaded.

Four axially loaded syringe-style reservoirs 104a-104d are shown seated in slots 102a-102d. Docking forms (i) a sealed positive-pressure air-in connection to drive the plunger 121 (FIG. 5) and (ii) a sealed liquid-out connection to the hub's liquid lines 115a-115d. When docked, 103a-103d can read 120 to identify contents (e.g., content class, strength, batch) and update remaining-volume estimates after fills, supporting inventory integrity and auto-reorder logic. Suitable reservoir body materials can include COC/COP, PETG, PCTG, or medical-grade PP for solvent compatibility and shelf life; seals can include LSR and FKM/EPDM depending on the formulation.

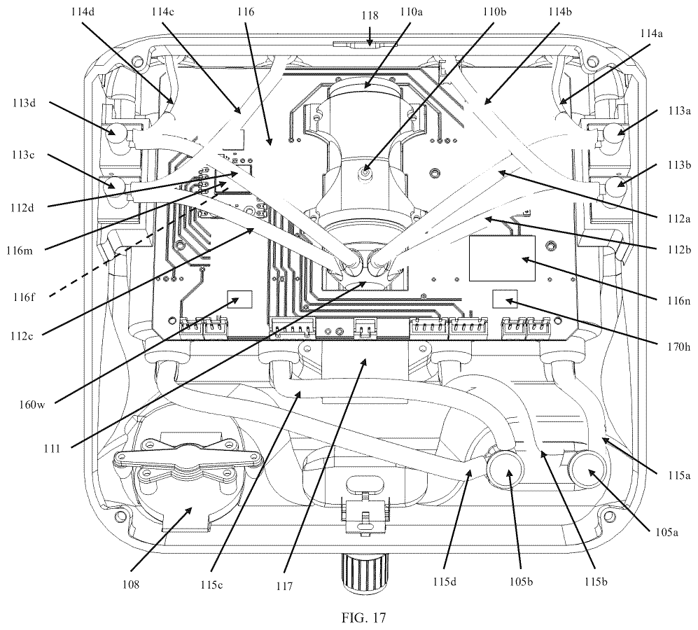

FIG. 17: Hub Internals (Underside with Base Removed)

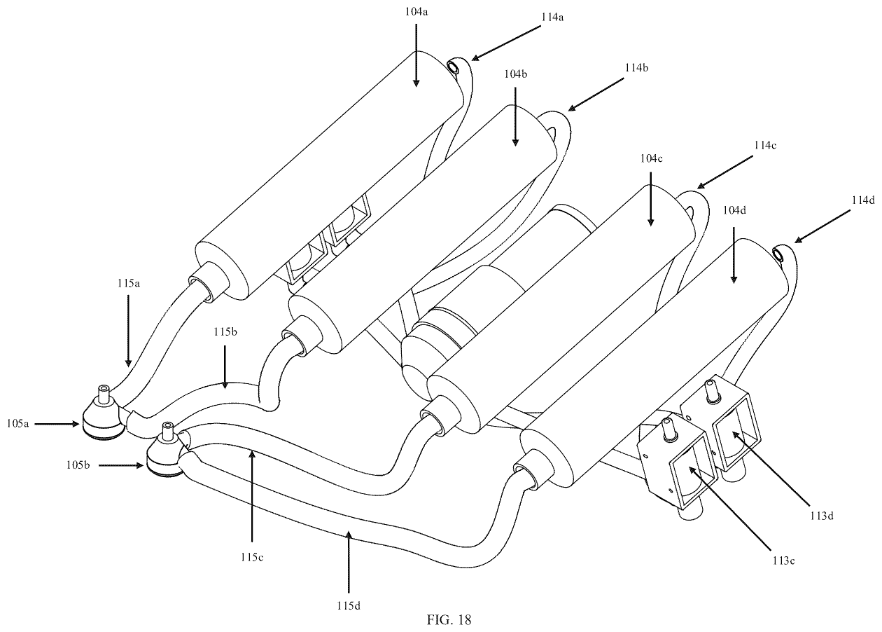

A pump 110a draws through inlet 110b and supplies a manifold 111. Air lines 112a-112d feed solenoids 113a-113d (normally closed). When a solenoid opens, pressure is routed through the paired airline 114a-114d to the corresponding docked reservoir (FIG. 18), advancing its plunger 121 and displacing liquid through liquid lines 115a-115d toward 105a (left) or 105b (right). The motherboard 116 hosts the controller (MCU/SoC) 116m, drivers for 110a and 113a-113d, LED and display (108) control, and flash interfaces to reservoir and pod memory. Firmware 116f is depicted as a logical element; it comprises executable instructions stored in hub memory 116n and executed by controller 116m. The board may execute integrity checks (e.g., CRC/signature), write per-fill composition/level data to pod memory 54 and/or control body memory via cradle 106, and log dispense deltas for app/cloud sync. Speaker 117 can provide UI tones; power-in 118 (USB-C) supplies external power and can act as a data path. Illustrative operating values (non-limiting): a 12 V DC pump (≈300 mA) feeding the manifold; cycle periods of about 20-100 ms (10-50 Hz) for blend uniformity; dual-chamber fill times on the order of ≤3-15 s depending on viscosity; and target blend precision of ±3% absolute with volume accuracy of ±5% using time-at-flow models (sensorless) or tighter with closed-loop sensing.

### FIG. 18: E-Liquid Conveyance Sub-Assembly.

This view isolates the paired air and liquid paths from solenoids 113c-113d to reservoirs 104c-104d, representative for all four channels. Air lines 114a-114d route positive pressure to reservoir inlets 119a. Liquid displaced from each reservoir exits at outlets 119b and travels via liquid lines 115a-115d to the respective pod junction—115a/115b→105a (left); 115c/115d→105b (right)—allowing single-pass co-delivery from one or two sources into a given chamber. Oscillated in-flow blending. When two reservoirs feed one junction (e.g., 115a and 115b into 105a), the controller duty-cycles 113a/113b so the in-flow composition matches the commanded ratio. Cycle periods may be selected such that the plunger advance per open window is small relative to the total stroke, creating interleaved micro-slugs that mix prior to or at the chamber inlet; when only one source is selected, the line actuator may be held continuously open (0 Hz). Alternatives include differential metering using per-line micro-pumps in place of 113a-113d or closed-loop ratio control using pressure/flow/plunger-travel feedback. Residual fluid management. Service access through lids 109 allows quick-disconnect flushing; variants include a rinsing reservoir with a dump-pod routine or a reversible hydraulic design to retract residuals, all governed by content-class rules to limit cross-contamination.

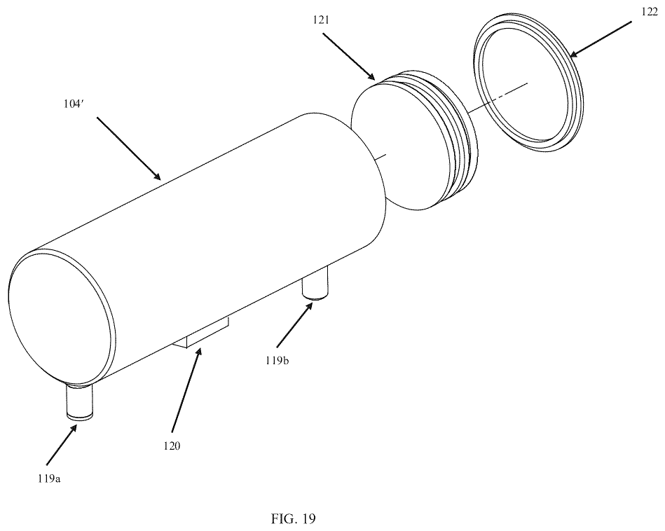

### FIG. 19—Syringe-Style Reservoir (Vertically Loaded Embodiment).

A reservoir body 104′ integrates at a dual-port base a positive-pressure air-inlet 119a and a liquid outlet 119b, the base being keyed for leak-proof, one-way engagement with a complementary hub interface. The module docks vertically into a hub slot; when docked, a pressure source coupled to 119a advances a plunger 121 (e.g., LSR head) to displace liquid through outlet 119b toward the hub's liquid line. Ports 119a/119b are normally closed by self-sealing septa or micro-poppet valves and open only under proper hub engagement, mitigating leakage during handling and hot-swap.

On-module memory 120 (e.g., low-power PC EEPROM or functionally equivalent ID/flash) stores both factory data and runtime fields. Factory fields can include a unique identifier (UID), content class, nominal concentration/strength, nominal fill volume, batch/lot, and manufacturing/expiry metadata. Mutable/runtime fields—updated by the hub after each dispense—can include an estimated-remaining-mL counter, a ring buffer of dispense events (timestamp+mL), a last-slot identifier, health flags (e.g., valve-timeout, temperature-exposure), and a reorder threshold. Integrity checks (CRC and/or digital signature) can be used to verify read/write operations and support auditability across fills.

Materials and sealing (non-limiting examples). The syringe body may be formed from COC/COP, PETG, or PCTG; plunger seal from platinum-cured silicone (LSR); and O-rings from FKM/EPDM selected per solvent system. Electrical contact pads for 120 can be plated for ≥10k mate cycles. Shelf-life can be enhanced via nitrogen flush with low-O₂ headspace; tamper-evident bands and UID labels may be matched to the memory identity to support chain-of-custody.

Safety/empty detection heuristics. During a fill the hub can infer near-empty or fault states by monitoring pump/valve current, elapsed open time without expected volume advancement, and/or repeated cavitation events. Upon detection the cycle can gracefully stop, prompt the user, and update the reservoir's runtime fields (e.g., est_remaining_ml and health_flags) to preserve inventory integrity.

Granular memory fields and analytics. In some embodiments, the dispense_events[ ] ring buffer stores per-event {timestamp, mL, slot_id, policy_bits}, enabling reconciliation even after hot-swaps and supporting cloud/app analytics for run-out prediction and auto-reorder.

Optional cap and one-piece variants. A removable reservoir cap 122 (threaded or quarter-turn) can be used for service or manufacturing line fill; in an alternative sealed, one-piece embodiment 122 is omitted and the syringe ships factory-sealed.

Axial- Vs. Vertical-Load Equivalence.

The vertically loaded module 104′ is structurally and functionally equivalent to the axially loaded reservoirs 104a-104d, except for docking geometry and port orientation shown in FIGS. 16, and 17. In axial-load builds, the air-in 119a and liquid-out 119b ports are arranged on the end-face that mates along the reservoir's longitudinal axis to suit axial insertion; in the vertical-load build of FIG. 19 the ports are disposed at the dual-port base for top-down insertion. In all cases the modules employ the same positive-pressure plunger actuation 121, normally-closed porting (septa/poppets), and on-module memory 120 with the factory/runtime semantics above. Thus, unless expressly stated otherwise, references to reservoir plunger actuation, porting, and memory features apply interchangeably to both load orientations.

Manufacturing and QA (illustrative). A two-shot or insert-molded base can integrate the valve seats for 119a/119b with minimal seals. Qualification may include pressure-hold and valve-actuation tests at ≥1.5× the hub's maximum operating pressure, memory read/write verification (including integrity fields), tare-mass capture for filled volume corroboration, and thermal/transport exposure logs written to 120.

Regulatory/compatibility note (non-limiting). Content-class/policy bits stored in 120 can gate hub behavior (e.g., purge requirements between classes, regional flavor/strength restrictions) without changing reservoir hardware. Materials cited above are typical for e-liquid contact and may be substituted with functionally equivalent solvent-compatible plastics and elastomers per SKU.

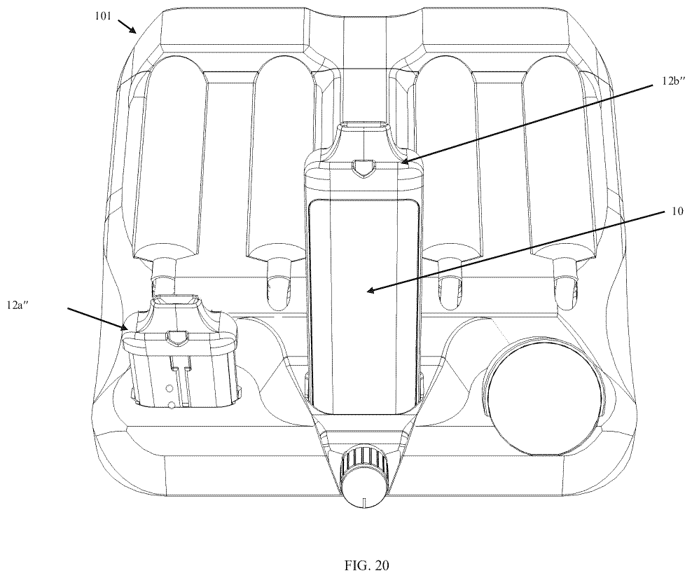

### FIG. 20: Hub (Fully Loaded)

A pod 12a″ is shown docked at fill section 105, and a pod 12b″ is shown inserted into the control body 10 resting in cradle 106. After completing a fill, the hub can write a signed composition record to pod memory 54 and/or to control body memory via a contactless channel at the cradle (e.g., NFC, BLE, or an inductive charging sideband). The control body 10 may then use that record to independently modulate per-chamber output (e.g., PWM envelopes for resistive atomizers or amplitude/frequency envelopes for ultrasonic) to realize commanded A:B blends for recreation or reduction programs, with inventory-aware guardrails and perceived-density compensation based on draw telemetry. Visual cues may be rendered by 103a-103d and audio cues by 117 during fills and verification.

### FIG. 21 (Remote/Manufacturer Line-Multi-Pod Filling).

A manufacturer-side or remote filling line in which multiple pods are advanced on a conveyor and coupled to dual pumps via fluid conveyance lines for automated fills. The line supports high-throughput, recipe-driven operations using positive-pressure delivery and fast couplers. (A conceptually similar remote filling station is depicted in the earlier drawings set.)

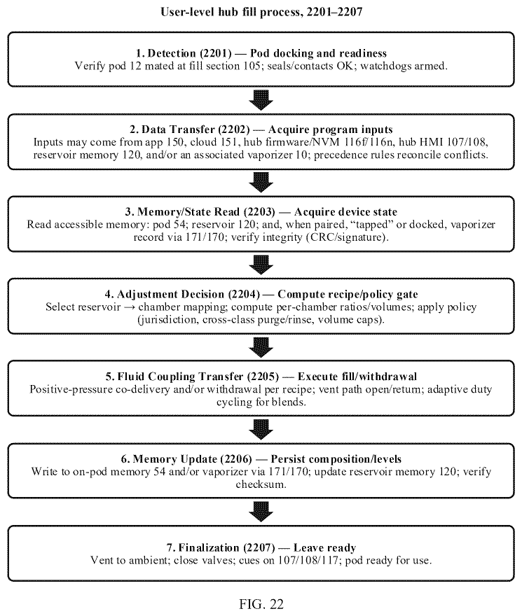

Referring now to FIG. 22, a representative workflow is shown for preparing a multi-chamber pod 12 at the hub 101. The figure illustrates a sequence of seven operations labeled 2201-2207. For clarity, the step labels (2201-2207) in this section correspond to the numbered callouts in FIG. 22 and denote process operations rather than structural elements. Structural elements referenced below use the numerals already assigned elsewhere in this specification (e.g., hub 101, pump 110a, manifold 111, solenoids 113a-113d, fluid lines 115a-115d, pod refill interfaces 127a/127b, vents 128a/128b, pod memory 54, reservoir memory 120).

### 1. Detection (2201): Pod Docking and System Readiness.

Upon insertion of a pod 12 into the hub's fill section 105, the hub 101 detects proper engagement (2201). Mechanical alignment features on 105 mate with the pod's self-sealing refill interfaces 127a (left chamber 22a) and 127b (right chamber 22b) and, in some variants, a vent/return port that couples to vents 128a/128b. Detection can be achieved by one or more of: (i) a latching micro-switch or Hall sensor that confirms physical presence; (ii) pressure-decay or seal-check routines that verify the couplers are seated; and/or (iii) electrical contact with on-pod memory 54 through the pod-bay interface.

A mis-dock watchdog inhibits pump 110a and line actuators 113a-113d until positive docking is verified. If a partial engagement is sensed (for example, an intermittent coupler seal or an unexpected pressure ramp), the hub vents the manifold 111, halts the sequence, and prompts the user via display 108, LEDs 103a-103d, and/or speaker 117. These checks protect against leakage and cross-connection before any fluid transfer begins.

### 2. Data Transfer (2202): Acquisition of Program Inputs and User Preferences.

Responsive to detection of a pod (2201) or in a pre-arm state prior to docking, the hub 101 obtains program inputs for an upcoming session (2202). Program inputs can include, without limitation, a user-selected mode (for example, recreation or reduction), per-chamber target compositions or ratios, dosage trajectories, schedules, and policy or safety parameters. Data may be sourced from any one or more of: (a) a companion application and/or remote service communicatively coupled to the hub (for example, Wi-Fi, Bluetooth Low Energy (BLE), a wired link, or functional equivalents) and configured to provide user plans, target compositions, and policy parameters; (b) one or more profiles stored locally by hub firmware 116f and/or associated non-transitory memory 116n; and/or (c) an Adaptive Control body 10 that is mechanically docked (for example, seated in a charge/data cradle 106) and/or proximally or operatively coupled to the hub through a contactless interface positioned on or within the hub housing (for example, NFC, BLE, an inductive sideband, or a functionally equivalent short-range discovery channel). In the proximally coupled case, the control body is brought within an operative proximity to a designated tap region sufficient for the selected interface to complete device discovery, optional authentication/authorization, association, and data exchange, thereby enabling the hub and control body to share state information such as last-known usage, reservoir estimates, or schedule metadata. Communications can be encrypted and/or signed.

In some embodiments, the data of step 2202 is obtained via a local user interface of the hub (for example, display 108 with touch, discrete buttons, rotary input 107, capacitive touch, gesture sensor, microphone/voice input, haptic or auditory interface), through which a user may enter or modify any of the foregoing inputs, in addition to or instead of data received from a service and/or memory associated with the pod or the control body 10 (for example, on-device non-volatile memory described elsewhere herein). Unless expressly stated otherwise, step 2202 is not limited to any particular transport, protocol, coupling mechanism, data format, or source.

### Manual Program Override Via Local HMI (Optional).

In some embodiments, a user may override, suspend, or bypass a predetermined program and manually specify per-chamber blend parameters using a local control element 107 (for example, a rotary encoder with integral push-button, a potentiometer with detent switch, a touch or voice control, or a functional equivalent) and/or any of the HMIs noted above. Upon entry into a manual mode, the hub identifies an active chamber (one of 22a or 22b) based on the orientation of the inserted pod and/or explicit user selection. Orientation may be determined by one or more indicators (for example, mechanical keying; a Hall-effect sensor; an optical code; an accelerometer; or electrical contacts interfacing with a pod PCB 53, the contacts providing identification and/or orientation information via resistive coding, discrete digital pads, or a serial interface such as I2C, 1-Wire, or UART; or by software mapping). The hub then presents controls to set an A:B mixture for that active chamber from a paired set of reservoirs mapped to that chamber. First-chamber ratio selection (optional UI implementation). When the first chamber is active, the two associated reservoirs (for example, 104a and 104b) may be visually emphasized while remaining reservoirs (for example, 104c and 104d) are de-emphasized. Each reservoir can be identified to the user by an illumination pattern on LEDs 103a-103d, which in one implementation defaults to a color, hue, pattern, or other indicator conveyed by a reservoir identifier or memory element (for example, to denote a content class), with user-modifiable mappings via a companion application and/or on-device settings. Rotating control element 107 adjusts the commanded A:B ratio for the active chamber. Indicators on LEDs 103a and 103b may vary in a manner correlated to the selected ratio (for example, relative brightness, duty cycle, gradient, bar-graph fill, or another monotonic transition) to provide at-a-glance feedback, while display 108 provides a numeric readout (for example, “A:B=60:40%”). A confirmation action (for example, pressing the rotary encoder, actuating a soft key, or a voice confirmation) accepts the selection.

### Second-Chamber Ratio Selection and Confirmation (Optional UI Implementation).

After the first selection is confirmed, the system advances to the remaining reservoir pair (for example, 104c and 104d) to set the mixture for the other chamber (22b or 22a, depending on orientation) using the same interaction model and feedback mechanisms. Upon confirming the second selection, the hub may present a summary of both chamber settings on display 108 and/or via LEDs 103a-103d, optionally with animations and/or accessibility cues. If the user confirms, the hub proceeds to subsequent steps (for example, recipe computation and filling). If the user cancels or times out, the system can revert to a previously active program or a default profile and may record an audit entry.

The imported dataset can include, by non-limiting example: desired per-chamber target strengths (for example, CH and CL), requested A:B blend ratios per chamber, target volumes or top-off deltas, inventory guardrails, and jurisdictional or content-class constraints. Unless stated otherwise, percentages and ratios refer to volumetric proportions at dispense conditions; other bases (for example, mass fraction) may be used in alternative embodiments. Each record can include integrity fields (for example, a CRC, message authentication code, and/or digital signature) that the hub verifies before proceeding. If multiple sources provide inputs, the hub reconciles them using a precedence rule (for example, explicit app command>cached profile>device-provided hint), the rule being configurable by policy, and the hub logs any overrides to a non-volatile audit log.

### 3. Memory Read (2203): Pod and Reservoir Identity/State Acquisition.

In 2203, the hub reads the current state of the hardware it is about to actuate. The hub interfaces with on-pod non-volatile memory 54 to retrieve at least: a pod unique identifier (pod_uid), prior per-chamber composition and level (as last persisted after a hub or remote fill), an optional chamber map (for example, {high: 22a, low: 22b}), and—where implemented—per-chamber atomizer drive envelopes or limits for safe operation. The hub authenticates these fields using stored integrity values and timestamps.

Concurrently, the slot interfaces 103a-103d read on-module reservoir memory 120 for each docked reservoir 104a-104d to obtain content class, strength (for example, mg/mL), batch/lot, nominal volume, and estimated remaining volume. Where a reduction set is present, reservoirs advertising a common reduction_set_id and complementary roles (for example, high/low) are recognized automatically. Inventory sufficiency and content-class compatibility are checked at this stage; detected run-out or policy conflicts are surfaced to the user.

### 4. Adjustment Decision (2204): Recipe Computation and Policy Gate.

Using inputs from 2202 and measured/recorded states from 2203, controller 116m computes a fill/adjustment recipe (2204). The recipe can include, per chamber: (i) which reservoir line(s) will feed the chamber; (ii) a commanded in-flow composition ratio when two sources co-deliver to a single chamber; (iii) a target volume or time-at-flow; and (iv) an oscillation schedule for paired solenoids 113a-113d when duty-cycled co-delivery is used.

A policy engine evaluates content-class rules and jurisdictional limits (for example, blocking disallowed combinations, requiring a purge/rinse cycle before cross-class changes, or enforcing a 2 mL capacity variant). If the pod's last-known composition differs from the requested program in a way that risks cross-contamination, the hub can branch to a rinse routine using a cleaning reservoir and a dump-pod step before resuming. If recorded reservoir inventory is insufficient for the requested volumes, the hub may compute a best-effort adaptation (for example, proportionally scale volumes while preserving ratio), prompt for reservoir replacement, or defer the operation.

Illustrative ranges (non-limiting) for mixture fidelity include oscillation at about 10 to 50 Hz (broader 1 to 200 Hz contemplated), minimum on-time greater than or equal to actuator response (for example, 5 to 20 ms), and fill rates on the order of 0.2 to 5 mL/min per line, with viscosity compensation via voltage/PWM lookup tables.

### 5. Fluid Coupling Transfer (2205): Positive-Pressure Co-Delivery and Optional Withdrawal.

When the recipe is accepted, the hub executes 2205. Pump 110a generates positive pressure at manifold 111; selected solenoids 113a-113d open according to computed duty cycles to route air through lines 114a-114d into matched reservoir inlets 119a. Reservoir plungers 121 advance, displacing liquid through outlets 119b and liquid lines 115a-115d toward left and right pod junctions 105a/105b.

### Single-Source Delivery.

If one reservoir feeds a chamber, its line actuator may be held continuously open (0 Hz) for the duration of the fill.

### Co-Delivery (In-Flow Blending).

If two reservoirs feed one chamber during a single pass, their respective line actuators are duty-cycled to create interleaved micro-slugs upstream of 105a or 105b so that the in-flow composition matches the commanded ratio. The hub can equalize average pressure/flow across sources using per-line calibration and adapt cycle parameters to formulation viscosity.

### Venting.

Displaced gas exits via pod vents 128a/128b. In open-vent variants the gas is exhausted locally; in closed-loop variants the vent path returns gas to the hub (for example, to a return manifold or pump inlet 110b).

### Metering and Termination.

Transfer can be metered by time-at-flow (sensorless) or by closed-loop sensing (for example, pressure/flow/plunger-travel where provided). The hub terminates upon reaching target volume/time, on detection of near-empty reservoir behavior (for example, cavitation or pressure rise), or upon a fault condition. Typical dual-chamber fills complete within about 3 to 15 s depending on viscosity and other relevant parameters (non-limiting).

### Optional Withdrawal/Replacement.

In an adjustment mode that requires composition reversal (for example, a cross-class change), the hub may first withdraw fluid from a chamber through a dedicated outlet path or via a dump-pod routine before refilling with a substitute composition. Residual-fluid management can include a reversible hydraulic stroke, user-accessible quick-disconnect flushing under lids 109, or an automated rinse using a cleaning reservoir, all governed by content-class rules.

### 6. Memory Update (2206): Persistence of the Post-Fill Composition/Level.

After fluid transfer, the system persists the results (2206). The hub writes a Reduction/Composition Record to accessible memory, which can include any one or more of: (i) on-pod memory 54; (ii) control body memory via a contactless link at 106 (for example, NFC/BLE/inductive sideband) while the control body 10 is seated; and/or (iii) a synchronized app/cloud log. A representative record includes at least: {pod_uid; chamber_map: {left: 22a, right: 22b} and, when applicable, {high, low}; per-chamber composition (for example, CH_mgml, CL_mgml or equivalent); per-chamber volumes_ml (or level estimates); recipe and policy metadata (content-class flags, jurisdiction bits); timestamp; integrity field (checksum/signature)}.

The hub verifies each write (for example, read-back plus checksum). Reservoir memories 120 may also be updated with dispense deltas, adjusted remaining-volume estimates, and any health flags (for example, near-empty or temperature exposure), enabling inventory reconciliation and optional auto-reorder prompts. If a write fails on one path (for example, pod memory), the hub can still complete the session by committing to an alternate path (for example, control body memory) and logging the condition.

### 7. Finalization (2207): Seal-Down, User Cues, and Ready State.

In 2207, the hub transitions to a ready state. Manifold 111 is vented to ambient; line actuators 113a-113d close; the pod couplers 127a/127b re-seal; and any return/vent paths are closed. The hub renders user-perceptible cues (for example, LEDs 103a-103d displaying blended colors corresponding to the achieved chamber ratios, text/status on display 108, and/or tones via speaker 117) confirming completion and indicating the compositions/levels now stored in memory.

If policy checks or integrity verification failed, the hub presents a blocking message and logs the event; otherwise, the pod 12 is released for use in the control body 10, which will thereafter read the persisted record to drive dual channels 18a, and 18b per puff according to the selected program while enforcing inventory-aware guardrails. Where a rinse or purge was performed, the hub may prompt the user to dispose of or re-dock the dump pod per instructions.

### Variations and Implementation Notes Tied to FIG. 22.

### Serviceability and Cross-Contamination Control.

Between sessions involving different content classes, the hub may automatically branch from 2204 to a purge/rinse sub-routine before returning to 2205, with behavior keyed to jurisdictional settings (mandatory purge versus user-acknowledged override with logging).

### Reservoir-to-Chamber Mapping.

Although a default arrangement routes reservoirs positioned in slots 102a and 102b to left chamber junction 105a (feeding chamber 22a) and slots 102c and 102d to right chamber junction 105b (feeding chamber 22b), the hub decouples physical slot index from logical destination. Using identities and metadata read from an on-reservoir memory device 120 (for example, EEPROM, NFC/RFID tag, 1-Wire, I2C, UART, or a functional equivalent), the controller performs mapping step 2204 to assign any installed reservoir to either chamber-singly or in combination-irrespective of the slot in which the reservoir is seated. In some embodiments, the on-reservoir memory 120 stores one or more of: a unique identifier, content class, nominal concentration, nominal/remaining volume, batch/lot, manufacture date, shelf-life, color/label hints, usage counters, and/or policy flags; any of the foregoing may be read and, where permitted, updated by the hub.

### Hot-Swap.

The system supports user hot-swap of reservoirs during idle or pre-fill phases: if a reservoir having certain contents is moved from slot 102a (normally associated with junction 105a) to slot 102c or 102d (normally associated with junction 105b), the hub detects removal and insertion events, re-reads and optionally authenticates the reservoir identity from memory 120, and updates the reservoir-to-chamber mapping accordingly. In some embodiments, the hub carries forward any user-specified targets or ratios previously associated with that reservoir identity (subject to policy constraints) or prompts the user to confirm or revise such settings. During an active dispense/fill step, hot-swap may be inhibited or may trigger an interlock, abort, or recomputation of the planned fill sequence prior to resumption. Unless expressly stated otherwise, mapping step 2204 is not limited to any particular plumbing topology, manifold, or switching element, and is independent of pod orientation and default left/right conventions. User overrides, default profiles, and last-known mappings may be reconciled by a precedence rule (for example, explicit user override>default profile>last-known mapping), and the applied mapping may be recorded to non-volatile storage for audit and recovery.

### Closed-Loop Metering (Optional).

In builds that include flow/pressure or plunger-travel sensing, 2205 can be executed under closed-loop control to improve volume accuracy (for example, toward ±2% total volume; ±3% absolute ratio), with the sensed values persisted in 2206 for audit.

### Failure Modes and Safe Handling.

Watchdogs monitor timeout/no-advance conditions, mis-dock seals, and abnormal current/pressure signatures. On any fault, the hub halts 2205, vents, and returns to a safe state before attempting a retry or prompting the user.

### Regulatory/Context Note.

The operations of 2201-2207 are device- and process-centric and operate independently of the specific active(s) carried in the fluids. Content-class flags and policy bits in 2202/2204/2206 allow the same mechanical/electrical workflow to gate or adapt options per jurisdiction without altering hardware.

FIG. 23 is a memory handoff diagram depicting redundant commit and read-back paths by which a hub 101 exchanges a recipe, profile, or other session record with a control body 10 and/or on-pod memory 54 so that the record remains available even if a particular interface is unavailable. Numerals in parentheses (2301-2308) indicate diagram operations, whereas device features (e.g., hub 101, interfaces 160/170/171, cradle 106, pod memory 54, reservoir memory 120) are identified by reference numerals.

Sources of profiles/recipes (2301-2303b). One or more sources can provide a record to the hub 101. In some embodiments, a client application 150 provides the record (2301) and/or a cloud service 151 provides the record (2302) over hub network interfaces 160 (e.g., Wi-Fi). In other embodiments or additionally, local device logic provides or recalls the record (2303), including hub firmware 116f and/or hub non-volatile memory 116n. Optional local sources include: (i) a hub HMI 107/108 by which a user creates or adjusts a plan (2303a); and (ii) on-module reservoir memory 120 (2303b) from which the hub can read formulation identifiers, strength, and estimated remaining volume, and to which it can later write inventory updates after a fill. Any one or more of 2301-2303b may be used independently or in combination and may occur in any sequence or concurrently.

Hub aggregation and path selection (2304). The hub 101 receives and aggregates whichever sources are available via interfaces 160 and selects one or more commit paths to persist or synchronize the record. Where multiple sources are present, the hub can apply a precedence policy (e.g., explicit user command via app/HMI over cached defaults) and can record the applied policy in non-volatile storage for audit.

Path A—Proximity write/read to control body (2307). In some embodiments, the hub transfers the record to the control body 10 using a hub-surface link 171 when the control body is brought to tap regions 171a-171c. This proximity mode can be contactless (e.g., NFC and/or an inductive sideband) and cooperates with a complementary control body interface 176. The same interface supports later read-back of state (e.g., usage or schedule position) for closed-loop refills.

Path B—On-pod persistence (2305). In other embodiments or in addition, the hub writes the record to on-pod non-volatile memory 54 when the pod is operatively coupled to the hub—e.g., mechanically mated in the pod fill section 105 or otherwise within a communication range sufficient for memory access. During subsequent sessions the hub and/or the control body can read back the last persisted per-chamber composition and level from memory 54 to guide operation or refilling.

Path C—Short-range radio link to control body (2306). In some embodiments, the hub writes the record to the control body 10 via a short-range radio link 170 (e.g., BLE) between a hub radio 170h and a control body radio 170v. The same link 170 can support read-back of state from the control body. Discovery and association can include optional authentication/authorization; communications may be encrypted and/or signed.

Path D—Docked write/read to control body (2308). In another embodiment, the hub writes the record to the control body 10 via hub-surface link 171 while the control body is seated in cradle 106. In this docked mode the control body 10 may be mechanically aligned and coupled by contacts and/or aligned inductive elements. The same interface 171/176 supports read-back while docked.

Bidirectional behavior and redundancy. For paths A-D, solid double-headed arrows in FIG. 23 denote interfaces that the hub can use in either direction—writing a record and subsequently reading back state—over the same interface or link. Any subset of paths A-D may be present; if one path is unavailable, the hub can commit or retrieve the record using another path without departing from the disclosed flow.

Closed-loop refill example (reduction program). In a representative reduction program, a pod previously filled with chamber-specific compositions (e.g., C_H and C_L) is returned to the hub. The hub obtains state via any active path A-D (e.g., reading per-chamber level and schedule position from memory 54 and/or from the control body 10). Using that state together with current reservoir metadata from 120 (2303b), the hub computes per-chamber deltas, checks inventory sufficiency, and executes a refill to maintain the program trajectory with minimal user intervention. After the fill, the hub writes depletion and remaining-volume updates to reservoir memory 120 and may synchronize inventory and a fill log to the client application 150 and/or cloud service 151 over network interfaces 160.

Recreational scenario. In recreation mode the hub can propose suggested refill volumes for chambers 22a, 22b derived from read-back state or accept a new user selection via HMI 107/108 (2303a) or client application 150 (2301) within system constraints (e.g., composition, compatibility, and volume limits). The resulting record is then committed by one or more of paths A-D.

Inventory and integrity updates. Following a fill, the hub can write dispense deltas and updated remaining-volume fields back to reservoir memory 120 (2303b), and synchronize fill events, usage estimates, and inventory with the app/cloud via 160 (e.g., Wi-Fi). Records and updates may include integrity fields (e.g., checksum/signature) and policy bits (e.g., content-class or jurisdiction flags).

Security and association (optional). Proximity and radio links can perform control body 10 discovery, optional authentication/authorization, and association; communications may be encrypted and/or signed. In some embodiments the hub 101 verifies a checksum or signature before accepting a record for use.

Ordering and omissions. Unless expressly stated, operations 2301-2308 need not occur in numeric order; any operation may be omitted when another suffices. The diagram depicts exemplary flows; equivalent sequences are contemplated.

Conventions. Arrows from sources (2301-2303b) to hub 101 indicate that the hub can receive the record from those sources; dashed double-headed arrows at 2303a/2303b denote optional local sources that can also be updated (e.g., inventory write-backs to 120). The A-D arrows denote interfaces usable for both write and read-back, as described above.

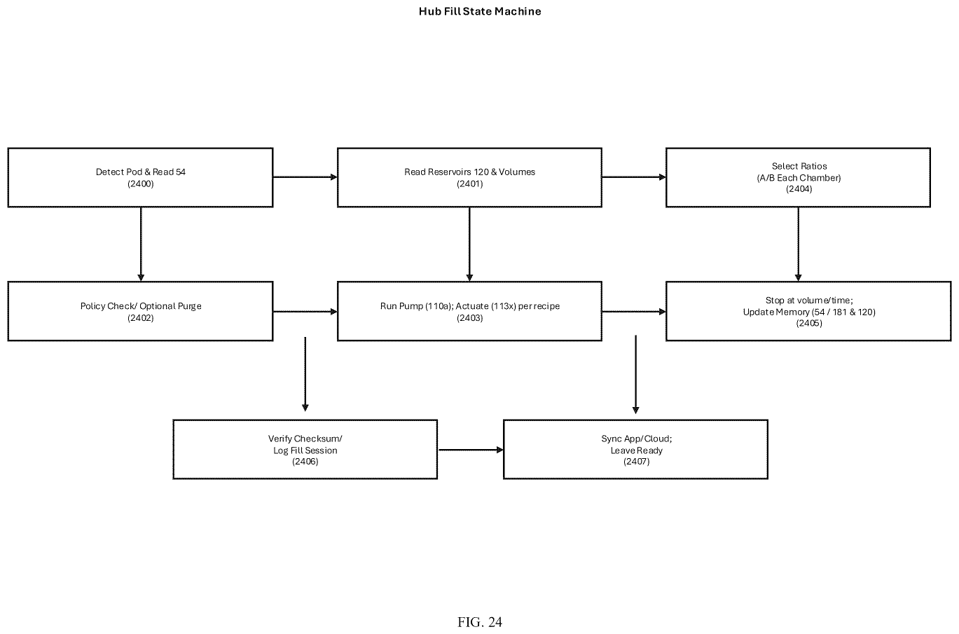

### FIG. 24: Hub Fill State Machine

A representative state machine is shown for a dual-chamber fill. The sequence begins with Detect Pod & Read (54), followed by Read Reservoirs (120) & Volumes to confirm identity and inventory. The user (or a profile) Selects Ratios (A/B) for each chamber. A Policy Check/Optional Purge state may gate the operation depending on content class or jurisdictional rules. The hub then Runs Pump (110a) and Actuates Solenoids (113a-113d) per recipe, advancing until Stop at Volume/Time; Update Memory (54 & 120). The flow concludes with Verify Checksum/Log Fill Session and Sync App/Cloud; Leave Ready. Variants may include sensor-assisted metering, rinse loops, or mapping changes if reservoir identities change.

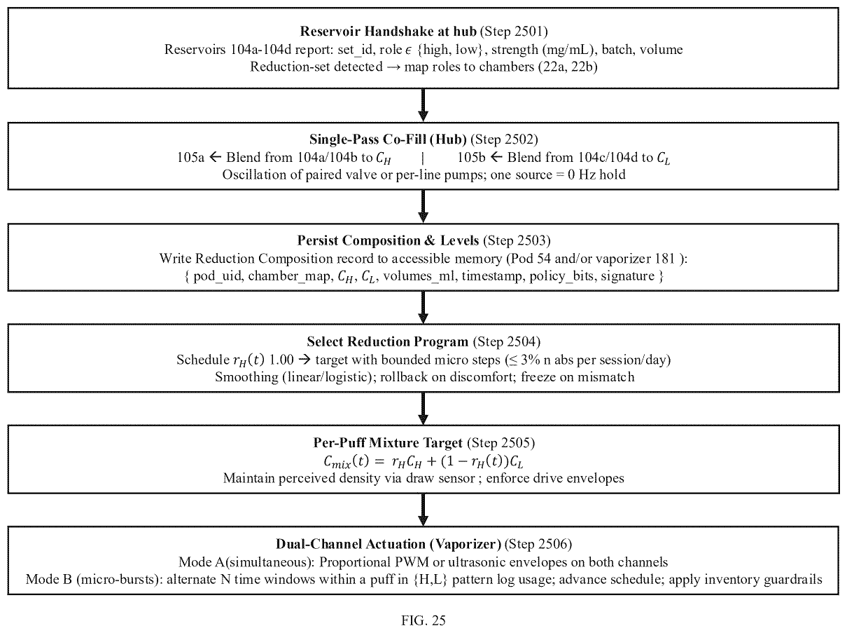

### FIG. 25: Reduction Program Flow (Hub→Control Body).

FIG. 25 shows and consolidates the reduction workflow. Reservoir Handshake at the hub: reservoirs 104a-104d report set_id, role∈{high, low}, strength (mg/mL), batch, and volume; a reduction-set is detected and roles map to chambers 22a, 22b. Single-Pass Co-Fill (Hub): 105a receives a blend from 104a/104b to produce C_{H}; 105b receives a blend from 104c/104d to produce C_{L}, (one source may be held at 0 Hz). Persist Composition & Levels: the hub writes a Reduction Composition Record to accessible memory (pod 54 and/or control body memory via 106), e.g., {pod_uid, chamber_map, C_H C_L, volumes_ml, timestamp, policy_bits, signature/CRC}. Select Reduction Program: firmware selects a schedule r_{H}(t) that steps from 1.00 toward a target with bounded micro-steps and smoothing; rollback may occur on discomfort or mismatch. Per-Puff Mixture Target: the control body 10 computes Cₘᵢₓ(t)=r_{H}(t)C_{H}+(1−r_{H}(t))C_{L} and maintains perceived density via draw-sensor feedback. Dual-Channel Actuation (Control body): Mode A drives both channels simultaneously with proportional envelopes; Mode B alternates N time windows within a puff (micro-bursts), logging usage and applying inventory guardrails.

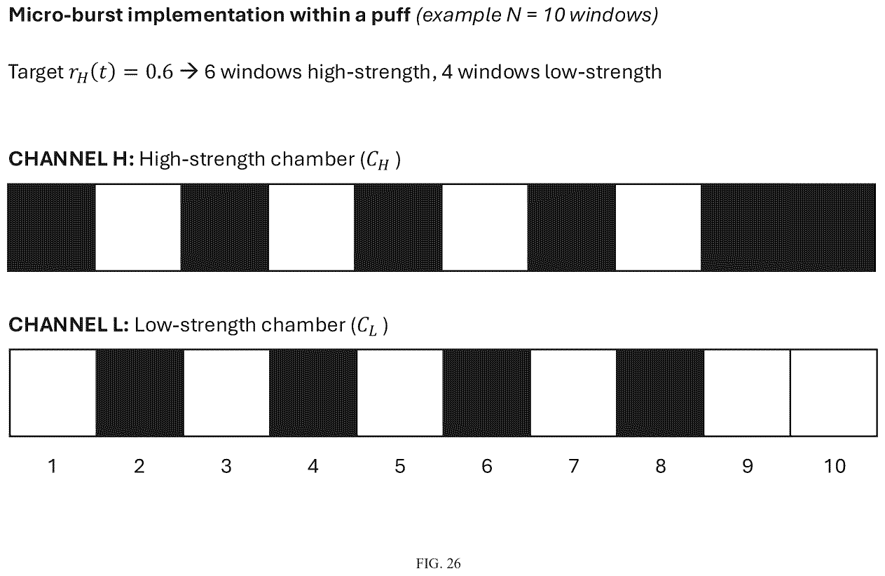

FIG. 26: Micro-Burst Implementation within a Puff

An example N=10 window puff is depicted. For r_{H}(t)=0.6, 6 of the 10-time windows are assigned to the high-strength channel (C_{H}) and 4 windows to the low-strength channel (C_{L}). The top bar shows the on/off pattern for Channel H, and the bottom bar shows the complementary pattern for Channel L. Window duration is at least the actuator response (e.g., ≥5-20 ms) and small relative to draw time (e.g., ˜300-800 ms total), yielding a perceived blend without noticeable switching. Alternative sequences (e.g., pseudo-randomized assignments) may be used to decorrelate audible or tactile signatures.

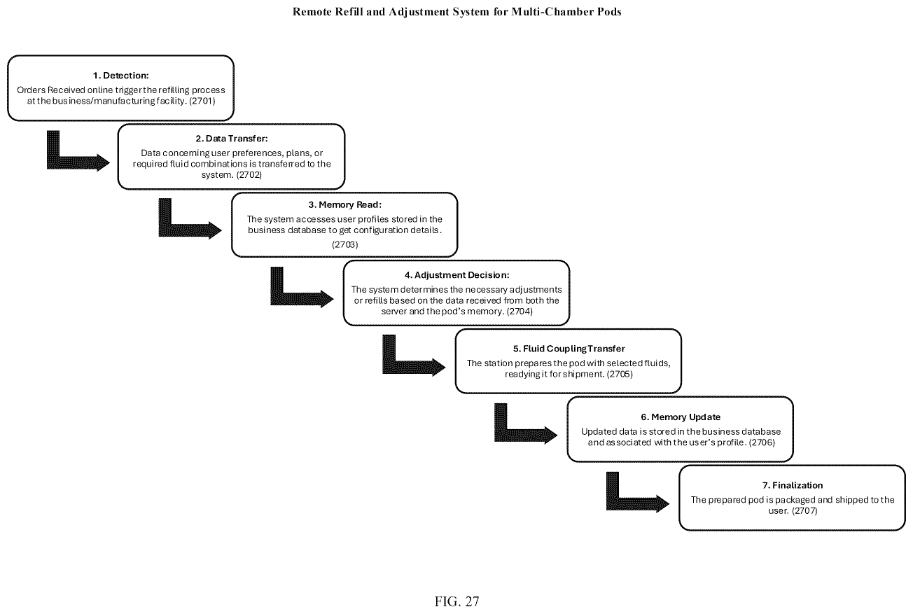

FIG. 27 is a flow diagram of a remote fulfillment method executed at a business-operated filling station. The method parallels the personal hub workflow and uses the same data model and composition record, but the pod is prepared off-site for shipment to the user.

Step 2701 (Detection)—an intake event is received (e.g., an online order, prescription, or service ticket) that identifies the user and the pod to be prepared.

Step 2702 (Data Transfer)—profile data are obtained, such as program type (recreation or reduction), target chamber ratios/strengths, policy parameters, and any device or account identifiers. Sources can include an application or cloud service and, where available, records previously persisted for that user.

Step 2703 (Memory Read)—the station accesses user records in a business database to retrieve last-known chamber levels or schedule position and, where applicable, a pod identifier or batch history for traceability.

Step 2704 (Adjustment Decision)—a controller computes the fill recipe for the pod, including reservoir-to-chamber mapping, commanded in-flow composition when two or more sources co-deliver to a chamber, target volumes, and any purge/rinse requirements under policy (e.g., cross-class transitions). Inventory sufficiency is checked and any adaptations (e.g., volume scaling) are applied.

Step 2705 (Fluid Coupling Transfer)—the station couples liquid sources to the pod's refill interfaces and executes the recipe (single-source or duty-cycled co-delivery) until the target volume/time is met; displaced gas is vented or returned in accordance with the station configuration.

Step 2706 (Memory Update)—a composition/level record is persisted for the prepared pod. In some embodiments the record is written to on-pod memory bound to a pod identifier; in others, or additionally, the record is written to a user-associated data store or device account for later verification when the pod is first used. The station updates its fulfillment log and inventory (e.g., dispense deltas, batch/lot), and may perform integrity checks (checksum/signature) over the stored fields.

Step 2707 (Finalization)—quality checks are performed and the pod is packaged and shipped. The method may include printing or encoding a label correlated with the stored record to facilitate use-time verification by the user's device. Variants may omit or reorder steps to accommodate operational constraints without departing from the disclosed remote-fill semantics.

### Computer Implementations

Implementations of the present disclosure may be provided on a computer system, a computer-implemented method, and/or a computer program product. The computer program product is not a transitory signal per se, and may include a computer readable storage medium (or media) having computer readable program instructions thereon for causing a processor to carry out aspects of the present disclosure. As described herein, the computer readable storage medium (or media) is a tangible storage medium (or media). It should also be understood by those of skill in the art that the terms media and medium are used interchangeable for both a plural and singular instance.

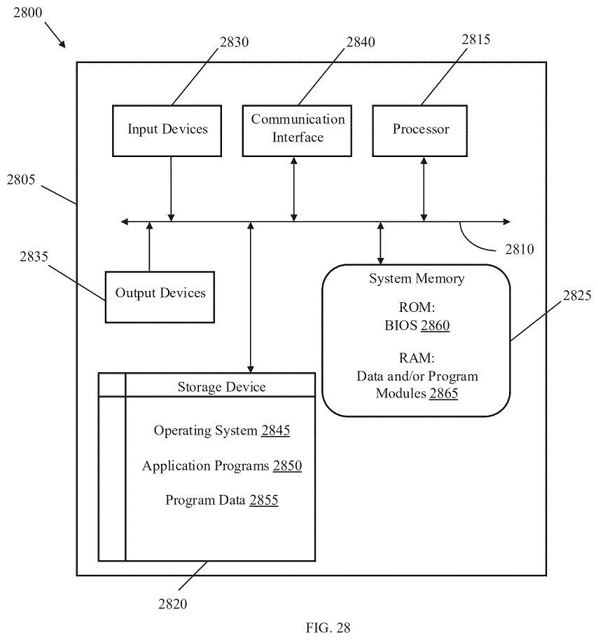

FIG. 28 is an illustrative architecture of a computing system 2800 implemented in embodiments of the present disclosure. The computing system 2800 is only one example of a suitable computing system and is not intended to suggest any limitation as to the scope of use or functionality of the disclosure. Also, computing system 2800 should not be interpreted as having any dependency or requirement relating to any one or combination of components illustrated in computing system 2800.

As shown in FIG. 28, computing system 2800 includes a computing device 2805. The computing device 2805 can be resident on a network infrastructure such as within a cloud environment as shown in FIG. 23 or may be a separate independent computing device (e.g., a computing device of a third party service provider). The computing device 2805 may include a bus 2810, a processor 2815, a storage device 2820, a system memory (hardware device) 2825, one or more input devices 2830, one or more output devices 2835, and a communication interface 2840.

The bus 2810 permits communication among the components of computing device 2805. For example, bus 2810 may be any of several types of bus structures including a memory bus or memory controller, a peripheral bus, and a local bus using any of a variety of bus architectures to provide one or more wired or wireless communication links or paths for transferring data and/or power to, from, or between various other components of computing device 2805.

The processor 2815 may be one or more processors or microprocessors that include any processing circuitry operative to interpret and execute computer readable program instructions, such as program instructions for controlling the operation and performance of one or more of the various other components of computing device 2805. In embodiments, processor 2815 interprets and executes the processes, steps, functions, and/or operations of the present disclosure as described herein, which may be operatively implemented by the computer readable program instructions.

In embodiments, processor 2815 may receive input signals from one or more input devices 2830 and/or drive output signals through one or more output devices 2835. The input devices 2830 may be, for example, a keyboard, touch sensitive user interface (UI), etc., as is known to those of skill in the art such that no further description is required for a complete understanding of the present disclosure. The output devices 2835 can be, for example, any display device, printer, etc., as is known to those of skill in the art such that no further description is required for a complete understanding of the present disclosure.

The storage device 2820 may include removable/non-removable, volatile/non-volatile computer readable media, such as, but not limited to, non-transitory media such as magnetic and/or optical recording media and their corresponding drives. The drives and their associated computer readable media provide for storage of computer readable program instructions, data structures, program modules and other data for operation of computing device 2805 in accordance with the different aspects of the present disclosure. In embodiments, storage device 2820 may store operating system 2845, application programs 2850, and program data 2855 in accordance with aspects of the present disclosure.

The system memory 2825 may include one or more storage mediums, including for example, non-transitory media such as flash memory, permanent memory such as read-only memory (“ROM”), semi-permanent memory such as random access memory (“RAM”), any other suitable type of storage component, or any combination thereof. In some embodiments, an input/output system 2860 (BIOS) including the basic routines that help to transfer information between the various other components of computing device 2805, such as during start-up, may be stored in the ROM. Additionally, data and/or program modules 2865, such as at least a portion of operating system 2845, application programs 2850, and/or program data 2855, that are accessible to and/or presently being operated on by processor 2815 may be contained in the RAM.

The communication interface 2840 may include any transceiver-like mechanism (e.g., a network interface, a network adapter, a modem, or combinations thereof) that enables computing device 2805 to communicate with remote devices or systems, such as a mobile device or other computing devices such as, for example, a server in a networked environment, e.g., cloud environment. For example, computing device 2805 may be connected to remote devices or systems via one or more local area networks (LAN) and/or one or more wide area networks (WAN) using communication interface 2840.

The computing device 2805 may perform tasks (e.g., process, steps, methods and/or functionality) as already described herein in response to processor 2815 executing program instructions contained in a computer readable medium, such as system memory 2825. The program instructions may be read into system memory 2825 from another computer readable medium, such as data storage device 2820, or from another device via the communication interface 2840 or server within or outside of a cloud environment. In embodiments, an operator may interact with computing device 2805 via the one or more input devices 2830 and/or the one or more output devices 2835 to facilitate performance of the tasks and/or realize the end results of such tasks in accordance with aspects of the present disclosure. In additional or alternative embodiments, hardwired circuitry may be used in place of or in combination with the program instructions to implement the tasks, e.g., steps, methods and/or functionality, consistent with the different aspects of the present disclosure. Thus, the steps, methods and/or functionality disclosed herein can be implemented in any combination of hardware circuitry and software.

Moreover, it should be understood by those of skill in the art that the exemplary flow diagrams described herein can be illustrative of a system, a method, and/or a computer program product and related functionality implemented on the computing system of FIG. 28, in accordance with aspects of the present disclosure. The computer program product may include computer readable program instructions stored on computer readable storage medium (or media). The computer readable storage medium may include the one or more storage medium as described with regard to FIG. 28, e.g., non-transitory media, a tangible device, etc. The method, and/or computer program product implementing the flow diagrams can be downloaded to respective computing/processing devices, e.g., computing system of FIG. 28 as already described herein. Accordingly, the processes associated with each flow of the present disclosure can be implemented by special purpose hardware-based systems that perform the specified functions or acts or carry out combinations of special purpose hardware and computer instructions.

### User Interface:

The device includes a versatile user interface that may be implemented as a physical HMI on the hub 101, such as a dial (e.g., rotary encoder, potentiometer, etc.), a screen 108, buttons, or other similar controls, enabling direct interaction with the device. Additionally, the interface may be fully or partially controlled through a client application 150, allowing users to manage and monitor their usage, adjust substance concentrations, and track progress over time. This hybrid approach provides flexibility, enabling users to create and save custom-defined profiles for substance mixes and access their preferred combinations either directly through the hub 101, control body 10, and or via the client application 150. The interface may also offer real-time feedback and supports dynamic adjustments based on the user's needs, ensuring that the system can be adapted to various user preferences and technological integrations.

Integrated Multi-Chamber System with Automated Filling.

In some embodiments, a system includes a multi-chamber pod having multiple fluid chambers, each chamber fluidly coupled to and controllable by an associated atomization element (e.g., resistive heater or ultrasonic transducer), a control body mechanically and electrically interoperable with the pod, and a hub under controller execution. The station is operative to perform chamber-specific filling, withdrawal, and concentration adjustment in accordance with user-defined preferences, reduction plans, and real-time feedback from the device/pod. The pod provides mating mechanical and data interfaces that enable sealed, repeatable coupling to the hub.

Customizable Vapor Output with Dynamic Integration.

The multi-chamber pod may implement any of a range of chamber counts. Per-chamber modulation of atomization provides a user-selectable vapor mixture by independently controlling output from different chambers. The hub can adjust fluid levels, concentrations, and substance combinations responsive to user behavior, input, and feedback so that the pod contents remain synchronized with the active program. Vapor streams may be combined within an internal mixing region or delivered through separate conduits for natural mixing during inhalation.

### Versatile Communication Protocols.

The hub, the control body, and the multi-chamber pod communicate via secure links, which may include NFC, BLE/Bluetooth®, Wi-Fi, and/or wired connections/contact connections/inductive? to synchronize settings and status with user interfaces, applications, servers, or other digital platforms in real time.

### Comprehensive Fluid-Management Capability.

The hub 101 incorporates a fluid-management subsystem capable of withdrawing and replacing fluids from any chamber of the multi-chamber pod to realize user-defined mix ratios and substance combinations.

### Personalized Reduction Programs.

The disclosed system can be used to implement personalized reduction programs in which chamber concentrations are gradually decreased over time based on user progress, preferences, inventory guard rails, and real-time feedback from the device/pod.

### Environmental Adaptation and Monitoring.

Environmental sensors located in the device, the pod, and/or the hub may monitor ambient and device-internal conditions—such as temperature, pressure and humidity—and automatically adjust vaporization parameters to provide consistent delivery performance.

### User Interface and Real-Time Control.

A user interface integrated with the system enables real-time monitoring and user adjustment of vapor output, chamber mixtures, and reduction plan parameters, with secure synchronization of settings and telemetry across devices and platforms.

### Combinations and Sub-Combinations.

Any suitable combination or sub-combination of the features described herein for the multi-chamber pod, control body, hub, communications, analytics, and methods may be implemented as needed.

The system comprises: (i) Hub 101 with pressure source, manifold, and per-line actuators; (ii) modular reservoirs 104a-104d, 104′, with 119a/119b and memory 120; (iii) multi-chamber pod 12 with refill interfaces 127a/127b and pod memory 54; and (iv) Control body 10 that reads the persisted composition and independently drives atomizers to achieve commanded A:B outputs. The ecosystem optionally includes a client application 150 and a remote filling station sharing the same data model.

At the system level, the disclosure further provides data and compliance features comprising: authentication of reservoirs 104a-104d and the pod 12 using identifiers stored in memory 54/120; a rules engine that constrains fills/programs by content class and jurisdiction; and a common data model that supports remote fill stations to prepare pods using the same single-pass, multi-source method and to write signed composition/level records prior to shipment. Alternative and fallback embodiments include mapping any reservoir slot to any pod chamber; a ≤2 mL volume limiter for regulated markets; gravimetric or volumetric verification of fill accuracy (e.g., ±2% total volume, ±3% absolute ratio); closed-loop vent return to the hub; and implementations scalable to three or more chambers. Collectively, these structures and processes enable reliable co-filling, trustworthy composition handoff, and adaptive dual-channel delivery while providing multiple implementation paths to preserve scope.

The present disclosure provides coordinated multi-source filling (including oscillated valve duty-cycling or equivalent metering), positive-pressure venting and residual-fluid management, and storage of the per-chamber composition/level in a data store accessible to the control body for later dual-channel delivery.

Manufacturing & jurisdictional variants. Tool-less volume limiters (≤2 mL); cost-reduced SKUs using read-only identification (e.g., NFC) rather than writable flash; industrial-capacity reservoirs for remote fill stations; coil-only, ultrasonic-only, or hybrid control body variants; three-plus-chamber pod versions using the same co-delivery semantics.

### 6. Safety, Interlocks, and Regulatory Note

Environmental & storage ranges; reliability notes. Non-limiting planning ranges can include operating and storage/transport conditions selected for target markets (e.g., normal indoor operation with tolerance for common transport vibration). Reliability practices may specify periodic self-tests, event logging, and serviceable sub-assemblies (e.g., tubing sets) to sustain performance over the product life.

### Optional Ranges and Alternatives (Cross-Figure, Non-Limiting)

Pump/pressure & flow. Pump 110a output can be selected to provide approximately 5-60 kPa line pressure; per-line flow rates on the order of 0.2-5 mL/min depending on viscosity, with controller compensation by voltage/PWM tables. Oscillation about 10-50 Hz (broader 1-200 Hz contemplated) with minimum on-time≥actuator response (e.g., ≥5 ms). As shown in FIG. 17 the pump 110a in this embodiment may be a positive pressure air pump. Other pumps are contemplated such as peristaltic diaphragm, etc.

Ratio accuracy. Blend precision±3% absolute of target and volume accuracy±5%, verifiable by time-at-flow models; closed-loop sensing (pressure/flow/plunger 121 travel) is a fallback embodiment for higher precision.

Materials. Wetted plastics may include PCTG/COC/COP/PETG/PP; tubing may be platinum-cured silicone; seals may be FKM/EPDM; housings may be PC/ABS blend or PC/ABS+stamped-metal skeleton for stiffness.

Hub: The hub 101 may serve as both a charging unit for the control body and an automated pod filling station. It includes multiple fluid reservoirs 104a-104d that can be filled with various substances, allowing users to choose and mix their preferred fluids. The design is modular, enabling users to add additional reservoirs, easily swap out fluids, and optionally add third-party fluids as desired.

Fluid Coupling System: The station uses a fluid coupling system to connect with the pod's fluid chambers, enabling precise control over the fluid levels in each chamber. This system may use needles, push fittings, or other known fluid transfer methods to achieve this connection. It also allows for the removal and replacement of fluids, giving users the flexibility to modify their substance ratios at any time without the need to purchase new products.

Automated Filling Process: The hub 101 is equipped with a microcontroller 116m that controls the filling process. It accesses data from the device or pod's memory module 54 to determine the appropriate fluid levels and concentrations for each chamber, adjusting them according to the user's reduction program or preferences. This dynamic adjustment feature is critical for tailoring the user experience.

### Advanced Features of the Hub:

Customization and Adjustment: The docking station is not just a passive filling device; it actively engages with the pod to adjust fluid levels, change substance concentrations, and manage the reduction plan. It can remove fluid from one chamber and replace it with another, enabling real-time customization. For instance, users can mix ratios such as 20% THC containing fluid, 10% caffeine containing fluid, and 70% nicotine containing fluid, and have these settings saved as a custom profile in a connected digital interface.

Wireless and Wired Charging: The docking station may support various power supply methods, including wireless charging, wired connections via USB 118, and solar charging if equipped with the necessary panels.

User Interaction: The docking station may be controlled via the same digital interface that manages the device, allowing for a seamless user experience. The digital interface may suggest adjustments to the reduction plan, notify the user when filling is needed, and provide data on usage patterns.

Hub—Functions and Data Coordination.

A user-possessed hub manages chamber filling, withdrawal, and concentration adjustment, including removal and replacement of fluids to achieve target ratios. The station maintains secure, continuous communication with the pod and the control body and may synchronize with application and server components. The station enables rapid “top-off” operations using pod/device/server-stored records describing chamber identity, levels, and composition

Adaptive learning and predictive feedback.

In certain implementations, a predictive analytics module executes on the hub or in associated software and adapts chamber filling parameters and per-chamber vapor output based on historical usage data, explicit user feedback, and relevant environmental conditions so that delivery is optimized over time.

Automated Hub with Modular-Pod Alignment.

A hub is configured to engage the modular multi-chamber pod, automatically align with refill ports, and manage chamber-specific filling, level adjustment, and fluid replacement so that chamber concentrations meet user preferences or program targets.

### Connection Sensing and Hands-Free Refill.

Station-side sensors and communication logic can detect pod connection and initiate a hands-free fill sequence based on current measured/recorded levels and predefined settings.

### Multiple Charging Options.

The hub 101 may serve as charging device for the control via wired charging, wireless charging (e.g., inductive), and solar-assisted charging.

### Automated Withdrawal and Replacement for Customization.

The hub 101 can automatically withdraw fluid from a chamber and replace it with a different fluid to achieve a commanded composition, including system-recommended adjustments.

### Modular Subsystem Design for Upgradability.

The hub 101 and multi-chamber pod 12 may be formed from modular subassemblies (e.g., reservoir modules, valve/coupler blocks, electronic control modules) to enable upgrades without replacing the entire system.

### Profile Synchronization Across Endpoints.

A synchronization module on the station can securely store and transfer user profiles-including reduction schedules and device preferences-across multiple devices, client applications 150 and cloud servers 151 to provide a consistent user experience.

### Coordinated, Adaptive Refill Mechanism.

The pod 12 and hub 101 operate cooperatively such that the station dynamically adjusts filling operations based on real-time pod 12, and or control body 10 data; each chamber 22a, 22b, is filled with the commanded substance and concentration, distinguishing the system from conventional manual refill approaches.

In one aspect, a hub 101 is provided, comprising a pressure source such as an air pump 110a with inlet 110b, a manifold 111, and a plurality of independently controllable line actuators selected from solenoids 113a-113d or per-line micro-pumps. The hub accepts modular reservoirs 104a-104d docked in slots 102a-102d, each reservoir including on-module memory 120, a positive-pressure inlet 119a, a liquid outlet 119b, and a plunger 121. During a single-pass chamber fill, a controller 116m co-delivers liquid from one or more selected reservoirs to a targeted pod junction—left 105a (chamber #1) or right 105b (chamber #2)—so that the in-flow composition matches a commanded ratio. When two sources feed one junction, the hub may duty-cycle the paired line actuators to interleave micro-slugs; when one source is selected, the corresponding actuator is held open (0 Hz). After the fill, the hub 101 persists per-chamber composition and level to accessible memory, which can include pod memory 54 and/or control body memory 181 written through contactless links provided at the charge/data cradle 106 (e.g., NFC—Near Field Communication; BLE—Bluetooth® Low Energy; or an inductive-charging sideband).

In another aspect, the hub's fluidics provide blend fidelity and serviceability. Illustrative operating parameters include pump pressure of about 5-60 kPa, per-line fill rates of about 0.2-5 mL/min, and oscillation frequencies of about 10-200 Hz with minimum on-time not less than actuator response (e.g., ≥5 ms). The system is adaptable to liquids having viscosities of about 20-500 mPa·s at 20-25° C. Liquid travels through e-liquid lines 115a-115d to the pod, while displaced gas exits through pod vents 128a/128b and may be routed back to the hub 101 for closed-loop venting. The hub 101 can include manual service lids 109 exposing quick-disconnects for purge/rinse cycles and residual-fluid management. Suitable materials for wetted components include PCTG/COC/COP/PETG for manifolds/junctions and platinum-cured silicone for tubing, with housings formed from PC/ABS blends; other solvent-compatible materials may be substituted. Ratio control may be achieved by duty-cycling valves, by differential pump speeds, or by a closed-loop scheme employing flow or plunger 121 travel sensing, thereby providing fallback embodiments that reduce design-around opportunities.

Fluidics. A positive-pressure pump 110a feeds manifold 111 (includes vent or valve that relieves pressure in the case of over pressure or some other form that keeps the hub 101 fluidic system from overpressure); branches pass through solenoids 113a-113d to reservoir inlets 119a. Opening a solenoid advances plunger 121 and displaces liquid via 119b→tubing 115a-115d→junction 105a/105b. For blended fills, paired solenoids oscillate at duty cycles proportional to the commanded ratio (e.g., 40:60), producing a substantially uniform in-flow mixture; if a single source is selected, its valve may be held open (0 Hz). Illustrative ranges: pump pressure 5-60 kPa; per-line flow 0.2-5 mL/min; oscillation 10-200 Hz (broader 1-200 Hz contemplated); minimum on-time≥5 ms. Closed-loop variants may employ flow, pressure, or plunger-travel sensing.

Controls/UI. Motherboard 116 hosts a controller (MCU/SoC) 116m with drivers for 110a and 113a-113d, LED/display control (103a-103d, 108), and speaker 117. The hub reads reservoir memory 120 and pod memory 54, computes recipes, executes purge/rinse (if enabled), runs fills, and persists composition/level data to accessible memory (on-pod and/or to the control body via the cradle 106 over NFC/BLE/inductive sideband). Slot LEDs can render content-coded color; chamber windows can render blended colors proportional to A:B during fills.

Residual fluid management. Options include reverse-stroke retraction, user-accessible manual flush via quick-latch tubing, or automated rinses using a cleaning reservoir with a dump-pod routine. Service access is provided beneath lids 109.

Pod-bay multi-coupler (docking). In some embodiments, the hub provides a multi-coupler head that aligns to the pod 12 base and furnishes left-in, right-in, and vent/return ports. Couplers may be needle-less magnetic quick-connects, spring-loaded tips, or a bayonet geometry, keyed so liquid and air paths mate only under a correct insertion angle. The vent path 128a, 128b can exhaust locally or route to a return line for closed-loop venting. Mechanical latching (magnet+detent or bayonet) may maintain seal compression over repeated cycles.

Slot/pod memory contacts. Each reservoir slot 102a-102d and the pod bay 105 can include 4-6 electrical pads or spring pins that mate to on-module memory (e.g., I²C EEPROM or NFC bridge). Contacts may be gold-flash plated, arranged for ESD-safe ingress/egress, and designed for on the order of 10k contact cycles; pad pitch and land geometry can tolerate light contamination while maintaining reliable read/write.

Representative user flow with LED mapping. A non-limiting flow includes: power-up self-check→insert reservoir and or reservoirs 104a-104d (slot LEDs 103a-103d adopt content-class colors, screen shows name/strength/batch/volume)→dock pod (Pod-DNA read)→set left-chamber ratio using slots 102a, & 102b with blended LED preview→set right-chamber ratio using slots 102c, & 102d→Fill (pump 10a runs; paired valves 113a-113d oscillate to the commanded ratio; chamber windows can show blended colors)→Write-back & sync to pod memory 54 and client application 150→remove pod 12 and control body 10.

Internal liquid architecture & wicking. Pod chambers 22a, 22b, may incorporate coil cans/tubes that form part of a chamber wall with seals to the air pathway, and wicking openings near the chamber bottoms to minimize residual liquid, reducing waste and improving consistency across orientations.

Airflow & mixing path options. The vapor paths 32a, 32b can remain separate to the mouthpiece 32d (natural mixing during inhalation) or merge in a mixing region upstream of the mouthpiece; anti-spit back features (baffles, mesh, or labyrinths) can mitigate droplet carryover. Both geometries are contemplated and may be selected per SKU.

The charge/data cradle 106 aligns the control body for wired charging and/or contactless data handoff (e.g., NFC, BLE, or inductive sideband) used to update accessible memory.

### Hub Data Model & Networking (Optional).

The hub synchronizes fill events, usage estimates, and inventory with an client application 150 or cloud service 151 via Wi-Fi 160w. Reservoir memory 120 holds UID, content class/strength, batch/lot, nominal volume, and mutable remaining-volume fields. Integrity checks (CRC/signature) and policy flags enable jurisdiction-specific gating.

Metering & calibration. In certain variants, dispensed volume is estimated by time-at-flow models tied to pump voltage and calibrated per formulation class, with corrections for pressure ramp-up and temperature/viscosity. The hub 101 may periodically refine estimates using plunger-travel inference (e.g., optical fiducial or slot-specific correction offsets) or by reconciling to fill-verification events from remote stations; these models can be stored as lookup tables and updated over-the-air.

Hub Fill Method. Detect pod; read reservoir identities/volumes; receive per-chamber ratios; select purge/rinse as required; start pump; for each chamber: (a) if two sources selected, duty-cycle the two line controllers to match the commanded ratio; (b) if one source, hold that controller open; advance until target volume/time; stop; persist composition/levels to accessible memory; verify integrity; log dispense deltas; synchronize to app/cloud. Oscillation cycle period can be adapted to viscosity via LUTs; ranges such as 10-50 Hz are suitable in certain builds; broader 1-200 Hz ranges are contemplated.

Watchdogs & mis-dock detection. The hub firmware may implement mis-dock and stall watchdogs, including: (i) pod-present sensing prior to enabling pump/valves; (ii) zero-flow/timeout conditions that halt a branch when commanded open time elapses without expected advance; (iii) near-empty detection (e.g., increasing pump 110a current or repeated early timeouts) that flags the source as depleted; and (iv) seal-check prompts when intermittent coupler engagement is detected. On any fault, the hub 101 can stop the cycle, vent pressure, and prompt the user for corrective action.

Safety, interlocks, cross-contamination control. Electrical/thermal protections; content-class interlocks; purge/rinse workflows; leak-resistant seals/ports; closed-loop venting; data-integrity checks. The hub 101 may block operations across classes unless a purge is performed, or alert and allow override (jurisdiction-dependent) with logging.

Known risks & mitigations. Potential risks include cross-contamination between formulations, accuracy drift due to viscosity/temperature variation, and assembly complexity. Mitigations can include residual-fluid management (reverse stroke, manual flush, or rinse reservoir+dump pod), adaptive pump/oscillation tables with optional sensors, and DFM improvements to reduce part count and simplify tubing paths.

Regulatory note: Regulatory positioning (non-limiting): the systems and methods described are device- and process-centric and agnostic to specific actives; any references to nicotine/cannabinoids are treated as content-class metadata for inventory/interlock gating rather than medical claims.

### 7. Materials, Manufacturing, and Environmental Ranges

### Materials, Dimensions, and Operating Ranges (Non-Limiting).

Wetted plastics: PCTG/COC/COP/PETG/PP; tubing: platinum-cured silicone; seals: FKM/EPDM; housings: PC/ABS or PC/ABS+stamped-metal skeleton.
Pressure/flow: 5-60 kPa at the manifold; 0.2-5 mL/min per line.
Oscillation: 10-200 Hz (broader 1-200 Hz contemplated); minimum on-time≥5 ms.
Viscosity envelope: ˜20-500 mPa·s (20-25° C.).
Volume-accuracy targets: ±5% (sensorless time-at-flow) improving with closed-loop feedback; blend precision: ±3% absolute.

Throughput & reliability planning targets. For engineering planning (non-limiting), embodiments may target dual-chamber fills in ≤60-90 s depending on viscosity and solenoid service life on the order of 10,000 cycles per valve channel, with tubing and seals selected for repeated coupling/decoupling; targets are illustrative and can be adjusted by SKU or market.

DFM & QA for reservoirs. In some embodiments, a two-shot or insert-molded dual-port base integrates the air-in and liquid-out seats with minimal seals; septa or micro-poppet valves can be validated to ≥1.5× the hub's maximum operating pressure. QA may include pressure-hold, valve-actuation, memory read/write, and tare-mass capture to support downstream analytics.

Single-pass, in-flow blending; reliable identity/volume handoff; adaptive dual-channel delivery; inventory/guardrails integrated across hub 101, pod 12, and control body 10; multiple fallback implementations (valves or per-line pumps; on-pod or on-device memory 54, and 181, respectively; open-loop or closed-loop metering)

The control body 10 consists of a main housing 14 and a modular, multi-chamber pod 12 that fits into the main housing 14. This device is designed specifically to support the gradual reduction of substance intake or the delivery of customizable substance mixtures for general use.

Seamless Integration with Hub:

The device is designed to work seamlessly with a hub 101 that may not only charge the control body 10 device when mated via cradle 106 but also serves to fill/refill the fluid chambers 22a, 22b, of the multi-chamber pod 12 as needed. This integration allows users to maintain a reduction plan or customize their substance mix without the need to purchase new pods as frequently, reducing waste, producing cost benefits, and an additional layer of convenience to the user.

### Pulse-Width Modulation for Per-Chamber Control.

Control circuitry may employ pulse-width modulation on a per-chamber basis to adjust vapor output from each atomization element independently, thereby setting vapor ratios and overall delivered concentration with fine resolution.

### Independent Per-Chamber Control at the Device.

The control body 10 can independently modulate vapor output from each pod chamber 22a, 22b to provide real-time customization of delivered mixtures.

Adaptive Control from User Telemetry.

Sensors in the control body may monitor inhalation or draw profiles and adjust vapor output dynamically according to user-defined profiles and real-time telemetry.

### Programmable PWM for Gradual Adjustment.

Pulse-width-modulation control in the control body 10 can be programmed to shift the ratio of vapor production between chambers over time, facilitating gradual reduction of active-substance concentration according to a schedule

### Integrated Device Housing and Secure Attachment.

The device housing may enclose vapor conduits, control electronics, and the interface to the pod's non-volatile memory 54, and atomizer elements 18a, 18b and can employ a complementary latch/mechanism to secure the pod 12 to the control body 10 for stable, leak-resistant operation.

### End-User UI for Customization and Monitoring.

The control body 10 may present a user interface through which a user inputs preferences, adjusts vaporization settings, and monitors real-time data; adjustments can be applied automatically in accordance with a user's program and synchronized with client applications 150 and or cloud servers 151.

### Anticipatory Management Using Predictive Analytics.

Predictive analytics may leverage historical usage and machine-learning models to anticipate user needs and proactively adjust delivery and filling parameters.

Dynamic Vapor-Adjustment Method with Gradual Reduction.

A representative method includes independently controlling vaporization for each chamber, adjusting the delivered mixture in real time according to user preferences and observed behavior, and progressively reducing active-substance concentration over time under program control. In a further aspect, a Control body 10 is configured to receive the multi-chamber pod 12 having chambers 22a, 22b, respective atomizers 18a, 18b, and outlets 126a, 126b. The control body 10 comprises two independently controllable atomizer drive channels to achieve a commanded A:B output per puff using persisted composition/level data. The atomizers may be resistive heaters (e.g., 0.3-2.0 Ω, 2-25 W, PWM at 10-30 kHz), ultrasonic transducers (e.g., 1.6-2.4 MHz with droplet sizes on the order of 1-5 μm MMAD), or a hybrid of both, with per-chamber drive envelopes bounded by limits stored in memory. A pressure sensor 42 enables draw-based perceived-density compensation to maintain substantially constant total aerosol output while preserving the A:B ratio. Inventory guardrails adapt or refuse user-requested ratios when a chamber's level falls below a threshold, with cues issued via speaker 117 and indicators 103a-103d. An airflow adjuster may be electronically sensed and logged to inform dosing analytics

Control body 10 receives pod 12, reads accessible memory, and drives two atomizer channels independently. Resistive example: PWM control of 0.3-2.0Ω coils over 2-25 W with optional NTC feedback. Ultrasonic example: 1.6-2.4 MHz transducers with amplitude/frequency envelopes. A pressure sensor 42 triggers per-puff control; an optional airflow adjuster is electronically sensed for analytics. The controller enforces inventory-aware guardrails (adapting or refusing ratios when a chamber is low). Speaker 117/LEDs 103a-103d, provide cues; BLE links 170h, 170v of the hub 101, and control body 10 respectively to the client app 150.

Expanded sensor suite. Beyond a pressure sensor 42 for draw detection, embodiments can include NTC temperature sensing for coil protection, an accelerometer for auto-wake and gesture input, a Hall sensor for pod detect, and an ambient-light sensor for LED auto-dimming. These sensors enable safer power envelopes and richer analytics.

Human feedback & locator. The device may include haptics (ERM or linear motor) for subtle cues (e.g., pre-cap notice, cap-reached, pairing), progress-ring LEDs 56a, 56b that visualize daily budget or A:B ratio, and a speaker/buzzer 190 for UI tones and Find-My-Vape chirps commanded from the client application 150 or hub 101.

### Pod and Memory Module:

The pod may be equipped with a PCB 53 containing a flash memory module 54 that stores any critical data such as but not limited to fluid levels, coil status, and usage history. This memory can be accessed and updated by both the control body 10 and the hub 101, enabling dynamic adjustment based on real-time data. The data from the pod can also be used by the user interface to suggest adjustments to a reduction plan or provide alerts when fluid within the pod chambers 22a, 22b, levels are low.

### Modular, Replaceable Pod Form Factor.

The multi-chamber pod 12 is modular and user-replaceable as a unit. While coils 18a, 18b, or other chamber-level atomization elements are not individually replaced, the control body 10 may accept different modules having varying chamber counts, coil/transducer types, or other characteristics

Multi-Chamber Pod with Independent Control.

In some embodiments, the multi-chamber pod 12 includes multiple fluid chambers 61a-61d, each configured to hold a distinct fluid and supply that fluid to a corresponding, independently controlled atomization element, enabling customizable vapor production from each chamber.

Dedicated Atomization Paths with Selectable Mixing.

Each chamber may feed a dedicated coil, or functionally equivalent mechanism for independent vaporization. Resulting vapor streams can be combined in a downstream mixing region prior to the mouthpiece or delivered via separate conduits for natural mixing during inhalation.

### Mixing Chamber or Direct-Delivery Variants.

Downstream of the atomizers, the pod may incorporate either: (i) a mixing chamber configured to combine per-chamber vapor streams before user delivery, or (ii) separate channels that convey vapor directly to the user, allowing natural mixing during inhalation.

### Leak-Resistant Integrated Housing.

The pod housing can integrate fluid chambers, atomization elements, and vapor passageways into a sealed unit designed to prevent fluid leakage and to protect the integrity of the vaporization process during normal handling and transport.

### On-Pod Non-Volatile Memory.

The pod 12 may include a flash memory 54 module storing data such as remaining fluid per chamber, current state of usage, dosage information, last-use time, substance type, and related parameters. This data can be accessed by the control body 10, hub 101, and associated client applications or cloud servers 151.

### Enhanced Refill-Port Safety.

Pod refill ports 127a, 127b can be engineered with interlocks and seals that resist leakage and contamination and that open only upon secure engagement with the hub 101.

Integrated User Interface: The entire system may be controlled via a digital interface, such as a client application 150, web portal, or API. This interface allows users to monitor their usage, adjust settings, and track progress in real-time. The interface may support the creation of custom defined profiles for substance mixes, allowing users to save and quickly access their preferred combinations.

Feedback and Adjustments: The client app 150 offers flexibility and convenience by enabling users to adapt their reduction plan on the fly. If a user finds that their current plan isn't working as expected, they can adjust their substance ratios or concentrations immediately without having to purchase new pods.

Privacy, security, and regional gating. End-to-end encrypted transport, scoped tokens, and least-privilege cloud roles may be employed. The system can implement age-gates and market geofencing so that content classes and program options are surfaced per jurisdiction, while on-module reservoir/pod memories store non-PII identity/inventory fields.

App/Remote fill (optional ecosystem layer). A client application 150 may pair with the hub 101 and control body 10, provides a blend-builder UI configures recreation or reduction programs, orchestrates, fills, verifies persistence (checksum/signature), and logs analytics. The same data model supports remote fills at fulfillment stations which perform the co-delivery fill and write composition/levels before shipment.

App-side features & tiers (optional). The App may provide journaling, streaks/badges, a blend recommender for recreation, predictive re-up for reservoirs 104a-104d, and auto-order, quiet hours with gentle nudges, and a Pro tier offering advanced analytics; features operate against the shared data model and respect regional policy flags. Include Lines about integrating with apple health, and similar platforms such as Samsung/android version, oura health ring, whoop, fitbit, etc.

Personal vs. remote filling flows. The ecosystem can support personal fills at the hub 101 and remote fills at a networked station using the same data model and memory handoff: detect→read identities→compute or apply profile→fill via oscillation or metering→write a signed composition/level record for later device use. Profiles generated in the client application 150 may be executed by either fill path without changing pod 12 semantics.

Remote fill method. At a networked station: receive user profile; couple liquid sources; execute multi-source co-delivery using oscillation or per-line metering; write signed composition/levels to accessible memory keyed to the pod UID; decrement industrial reservoir inventories; finalize shipment.

### Remote-Operated Hub (Facility Implementation).

In certain embodiments, a remote station includes: (i) a plurality of fluid reservoirs respectively holding defined substances or concentrations; (ii) a communication module configured to receive user- or system-supplied data originating from a control body 10, pod 12, or associated digital platform; and (iii) a fluid-coupling system that fills multi-chamber pods so that chamber volumes and concentrations conform to the received data. The station is operated at a facility (e.g., manufacturer or pharmacy/fulfillment site) to prepare pods per user settings and dispatch the filled pods to the user.

### Secure, Multi-Protocol Data Exchange for Remote Filling.

The communication module of the remote station may employ secure data-transfer protocols such as NFC, BLE/Bluetooth®, Wi-Fi, and internet-based services to receive real-time user preferences, schedules, and system settings that govern the pod-filling operation.

### Automated Controls for Precision Filling.

The remote station can execute automated controls that monitor and regulate the filling sequence, ensuring chamber-specific volumes and concentrations match the parameters derived from the received data for each user profile.

### Representative Method—Remote Pod Filling.

A representative method includes: receiving, at a remote facility, data originating from a user's control body, pod, or associated application; analyzing the data to determine required chamber volumes, concentrations, and mixture ratios; automatically filling a multi-chamber pod with corresponding substances and concentrations using the remote hub; and packaging and shipping the filled pod to the user for use with the control body.

### Personalization Inputs for Remote Filling.

The user data supplied to the remote facility may include reduction/reduction plans, historical usage patterns, and explicit user preferences, enabling the remote station to tailor chamber concentrations and volumes to the user's current program state.

### Scalable, Multi-User Fulfillment.

The remote hub can service multiple users concurrently by queuing and executing independent fill recipes for different pods based on separate data inputs, while maintaining isolation and traceability for each fulfillment event.

### Two-Tier Ecosystem—Personal and Facility Classes.

The system may provide both (i) a personal-use hub 101 that allows an individual to fill or extract fluids from a multi-chamber pod 12 based on real-time telemetry, user preferences, or system feedback, and (ii) a facility-use hub that receives user data from a control body 10, pod 12, or client application 150, prepares new pods with customized chamber volumes and concentrations per those inputs or reduction plans, and ships the prepared pods 12 to the user.

When in reference to a person hub a manufacturer-operated variant can execute the same recipes to fulfill user orders based on transmitted data.

Reduction Composition Record. After a fill, the hub writes a record to accessible memory comprising: {pod_uid; chamber_map: {high: 22a, low: 22b}; C_H_mgml; C_L_mgml; volumes_ml; timestamp; program_hint: reduction; policy_bits; integrity: signature/CRC}. The record may be stored on pod memory 54 and/or on the control body via the cradle 106.

Hub behavior: Upon detecting reservoirs with the same reduction_set_id, the hub maps role=high→chamber #1 and role=low→chamber #2 (or vice-versa), executes single-pass co-fills to produce C_{H} and C_{L}, and persists a Reduction Composition Record to accessible memory containing: {pod_uid, chamber_map: {high: 22a, low: 22b}, C_H_mgml, C_L_mgml, volumes_ml, timestamp, program_hint: reduction, policy_bits, signature/CRC}.

Program schedule. A Reduction Program defines a trajectory r_{H}(t) that monotonically decreases from 1.00 toward a target r_{H,target} over puffs or sessions subject to a bounded step size Δr_{H}≤0.03 absolute per step (other ranges 0.005-0.05 contemplated). Smoothing can be linear, staircase with micro-steps, or logistic. Rollback occurs if user-reported discomfort exceeds a threshold or if analytics flag relapse markers.

Delivered strength per puff. For a puff at time/index t: Cₘᵢₓ(t)=r_{H}(t)C_{H}+(1−r_{H}(t))C_{L}

The control body 10 maintains substantially constant perceived density by adjusting total output using draw telemetry while honoring r_{H}(t).

### Per-Puff Actuation (Two Implementations).

Simultaneous drive: each atomizer channel is driven concurrently with proportional envelopes: duty_{H} r_{H}(t)*dutyₜₒₜₐₗ, duty_{L}=(1−r_{H}(t))*dutyₜₒₜₐₗ. Resistive: PWM (10-30 kHz). Ultrasonic: amplitude/frequency envelopes.

Alternating micro-bursts: a puff window (e.g., 300-800 ms) is divided into N windows (e.g., 5-40). A fraction r_{H}(t) of windows are assigned to the high chamber and the remainder to the low chamber. Window length≥actuator response (e.g., ≥5-20 ms) and small relative to draw time, yielding a perceived blend.

Guardrails & drift detection. If remaining volume in a chamber falls below a threshold, the controller (i) adapts r_{H}(t) upward/downward, (ii) requests a refill, or (iii) refuses further steps. If C_{H}, C_{L}, differ from the last persisted reduction set, the program freezes and prompts the user.

Fallbacks. If C_{H}≈C_{L}, (difference below a small threshold, e.g., ≤2 mg/mL) or only one chamber is present, the device operates in recreation mode at a fixed ratio.

### Illustrative Ranges (Non-Limiting).

Step size per session: 0.5-3% absolute; per-puff micro-step: 0.1-1.0% absolute. Mixture computation and envelopes applied at 10-50 ms control cadence. Final target can be any value including 0 mg/mL; plateau periods may be inserted.

Example. For C_{H}=50 mg/ml and C_{L}=40 mg/ml, a day-based schedule might set r_{H}={1.00, 0.97, 0.94, . . . , 0.00}; the effective strength follows Cₘᵢₓ(t) from 50→40 mg/mL, then (if the low chamber is 0 mg/mL) from 50→0 mg/mL.

Non-limiting example of Pseudocode.

on_draw_start( ):
read R = {C_H, C_L, chamber_map, volumes}
rH = schedule.next_target( ) # obeys ΔrH ≤ step_max, smoothing
if volumes.low < Vmin or mismatch(R): freeze_or_adapt( )
duty_total = density_controller.target_duty(pressure, airflow)
apply_channel_envelopes(duty_H=rH*duty_total,
duty_L=(1−rH)*duty_total) # or micro-bursts
log_puff(Cmix = rH*C_H + (1−rH)*C_L, rH=rH, airflow, duration)
schedule.advance_if_needed(feedback=comfort_score)

### 5.3. Per-Puff Control Body Control

Control body Delivery Method. Read per-chamber composition persisted after the fill; receive a recreation or reduction program; during each puff, modulate two atomizer channels to meet the target A:B while maintaining perceived density using draw telemetry; apply guardrails if a chamber falls below threshold; issue cues; log usage; optionally enforce habit-taper budgets after zero strength.

On-device adaptation (TinyML variant). As an exploratory option, the control body MCU can run lightweight on-device inference that adapts taper tempo and density compensation to observed patterns (e.g., time-of-day usage, recent discomfort flags), within guardrails set by the program. This privacy-preserving path complements App-side analytics and may update targets per puff or per session.

### Terminology and Conventions (Definitions)

Chamber: a discrete liquid volume within a pod (22a/22b).

Accessible memory: any non-volatile storage readable by the control body, including on-pod memory 54 and/or on-device memory updated via cradle 106 (e.g., NFC=Near Field Communication; BLE=Bluetooth Low Energy).

Oscillation: duty-cycled actuation of two or more line controllers to interleave micro-slugs during a fill process.

Persisted composition record: a data structure indicating chamber composition and level after a hub-initiated fill.

High-strength chamber 22a has strength C_{H} (e.g., 50 mg/mL).

Low-strength chamber 22b has strength C_{L} (e.g., 40 mg/mL or 0 mg/mL).

Reduction-set: a matched pair of liquids stored in their own respective reservoirs who's respective on-module memories 120 advertise a common reduction_set_id and complementary role∈{high, low}, with fields strength_mgml, batch, and nominal_volume.

The foregoing examples have been provided merely for the purpose of explanation and are in no way to be construed as limiting of the present disclosure. While aspects of the present disclosure have been described with reference to an exemplary embodiment, it is understood that the words which have been used herein are words of description and illustration, rather than words of limitation. Changes may be made, within the purview of the appended claims, as presently stated and as amended, without departing from the scope and spirit of the present disclosure in its aspects. Although aspects of the present disclosure have been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

### REFERENCE NUMERALS

10 Control body
12 (12a, 12b, 12′ 12″) Multi chamber pod
14 Control body main housing
14a Control body main housing sidewall
15 Control body Display
16 (16a, 16b) Tab fitting mechanism
18 (18a, 18b, 18c, 18d) heating coils/atomizers, wicking openings, vapor conduits
20 wicking material
22 (22a, 22b) multi-chamber pod Fluid chambers
26 fluid & airtight passageways leading to pod coils
28 post atomizer fluid passageways
30 Opening in pod side wall
32 (32a, 32b, 32c, 32d) Vapor conduit pathways
34 Control body “Cup”
36 Control body Power pins
38 Control body Battery
40 “Cup” opening for airflow to be detected by pressure sensor
42 Control body Pressure sensor
44 Control body Motherboard/Circuit board
46 Pulse width modulator circuitry
48 “Cup” pins for additional rigidity and housing strengthening
49 Voltage Regulator
50 Microcontroller
51 Daughterboard
52 Flash Memory Pins
53 Pod PCB
54 Pod Memory Module/Flash memory
55 Pod Seal
56 Control body pod illumination LEDs
57 Automated Pod Docking station
58 (58a, 58b) Reservoirs
59 (59a, 59b) Fluid Pumps
60 Fluid Conveyance Lines
61 (61a, 61b) Additional Fluid chambers
62 Dual Fluid Pump (Manufacturing side hub)
63 Pod Conveyor (Manufacturing side hub)
64 Fluid Conveyance Lines (Manufacturing side hub)
101 Hub (assembly)
102a-102d Reservoir slots #1-#4
103a-103d Slot indicator+memory interface (LED bar and read/write interface)
104a-104d Reservoirs #1-#4 (Axially loaded embodiment)
104′ Reservoir (Vertically loaded embodiment)
105 Pod fill section: 5a left chamber junction; 5b right chamber junction
106 Control body charge/data cradle
107 Rotary encoder/selector
108 Display (OLED or TFT LCD; touch optional)
109 Manual release lids for residual fluid cleanup/line access
110a Pump; 110b pump inlet
111 Pump outlet and manifold
112a-112d Manifold-to-solenoid air lines
113a-113d Solenoids (line actuators)
114a-114d Solenoid-to-reservoir air lines
115a-115d Liquid lines to 105a/105b (115a/115b→left; 115c/115d→right)
116 Hub Motherboard (PCB)
116f Hub Firmware
116m Hub MCU Controller (MCU/SoC)
116n Hub non-volatile memory
117 Speaker
118 Power in (USB-C)
119a positive-pressure inlet; 119b e-liquid outlet
120 Reservoir On-module reservoir memory (UID/metadata)
121 Reservoir Plunger
122 Reservoir cap (optional; one-piece sealed body variant omits the cap)
22a, 24b Left/right chambers
125a, 125b Left/right atomizers
127a, 127b Left/right refill interlocks/inlets
128a, 128b Left/right positive-pressure vents
160w Wi-Fi Module (hub to cloud/app)
169 Control body USB-C female port
170h Hub short-range radio (BLE)
170v Control body short-range radio (BLE)
171 hub-surface couple link; 171a/171b tap regions (e.g., NFC or inductive/contacts), 171c in/at cradle 106.
176 Control body coupled interface that mates with 171 (e.g., NFC coil, inductive coil, or contact pads).
181 Control body non-volatile memory

We claim:

1. A device that can be integrated and used with the docking station comprising:
a first coil comprising a first vapor conduit;
a second coil comprising a second vapor conduit;
a first fluid chamber supplying a fluid with a first concentration to the first coil;
a second fluid chamber supplying a fluid with a second concentration the second coil;
a first passageway leading from the first vapor conduit of the first coil to an outlet; and
a second passageway leading from the second vapor conduit to the second coil to the outlet.
